(19) United States
(12) Patent Application Publication
(10) Pub. No.: US 2005/0086758 A1
(43) Pub. Date: Apr. 28, 2005

(54) System and method for cleaning or de-icing a windshield

(76) Inventors: Uri Arkashevski, Petach Tikva (IL); Joseph Rogozinski, Ramat Gan (IL); Vychislay Ivanov, Kiryat Tivon (IL)

Correspondence Address: LADAS & PARRY, 26 WEST 61ST STREET, NEW YORK, NY, 10023, US

(21) Appl. No.: 10/477,486

(22) PCT Filed: May 14, 2002
(86) PCT No.: PCT/IL02/00370

Related U.S. Application Data
(60) Provisional application No. 60/290,705, filed on May 14, 2001.

(51) Int. Cl. B60S 1/46

(52) U.S. Cl. 15/250.02; 15/250.04; 15/250.32; 15/250.351; 15/250.34; 239/284.1

(57) ABSTRACT

A windshield washing system and method including a windshield wiper and sprayer assembly (110). The windshield wiper and sprayer assembly (110) includes a windshield wiper assembly (114), a windshield wiper driver assembly operative to move the windshield wiper assembly (114) in rotational and linear motion along a vehicle windshield, a windshield sprayer assembly (116) mounted on the windshield wiper assembly (114), the windshield sprayer assembly (116) includes at least one sprayer. The sprayer includes a sprayer housing (136) and a sprayer housing closure (138) arranged for selectable positioning relative to the sprayer housing (136) and to assume a first position permitting spraying and a second position not permitting spraying and a windshield sprayer assembly positioning assembly operative in response to the linear motion of the windshield wiper assembly (114) for selectably positioning the sprayer housing closure (138) relative to the sprayer housing in either of the first and second positions in accordance with the rotational position of the windshield wiper assembly (114).

### REFERENCE TO RELATED APPLICATIONS

Reference is made to U.S. Provisional Patent Application Ser. No. 60/290,705, filed May 14, 2001 and entitled “Miniature De-Icing System”, priority of which is hereby claimed.

### FIELD OF THE INVENTION

The present invention relates to vehicle windshield washers, cleaners and de-icers generally.

### BACKGROUND OF THE INVENTION

The following Patent documents are believed to be relevant to the subject matter of the present invention:

U.S. patents:

| | | | | | |
|---|---|---|---|---|---|
| 653,629; | 1,636,190; | 3,202,447; | 3,332,045; | 3,977,436; | 3,979,068; |
| 4,090,668; | 4,106,508; | 4,159,026; | 4,253,493; | 4,295,111; | 4,306,589; |
| 4,403,756; | 4,489,863; | 4,561,632; | 4,534,539; | 4,524,797; | 4,574,841; |
| 4,690,371; | 4,877,186; | 5,012,977; | 5,118,040; | 5,280,806; | 5,254,083; |
| 5,318,071; | 5,345,968; | 5,351,934; | 5,354,965; | 5,383,247; | 5,509,606; |
| 5,727,769; | 5,784,751; | 5,927,608; | 5,947,348; | 5,957,384; | 5,988,529; |
| 6,133,546; | 6,164,564. | | | | |
| JP 2-53656; | JP 2-234866; | JP 63-93652; | JP 83-12824; | GB 1,451,666. | |

The disclosures of all publications mentioned in the specification and of the publications cited therein are hereby incorporated by reference.

### SUMMARY OF THE INVENTION

The present invention seeks to provide improved vehicle window washers, cleaners and de-icers generally.

For the purpose of this patent application the term “windshield” is given a broader meaning than usual and refers to any window, mirror or headlight surface of a vehicle.

There is thus provided in accordance with a preferred embodiment of the present invention a windshield washing system including a windshield wiper and sprayer assembly including a windshield wiper assembly, a windshield wiper driver assembly operative to move the windshield wiper assembly in rotational and linear motion along a vehicle windshield, a windshield sprayer assembly mounted on the windshield wiper assembly. The windshield sprayer assembly includes at least one sprayer, which includes a sprayer housing and a sprayer housing closure arranged for selectable positioning relative to the sprayer housing and to assume a first position permitting spraying and a second position not permitting spraying. The windshield washing system also includes a windshield sprayer assembly positioning assembly operative in response to the linear motion of the windshield wiper assembly for selectably positioning the sprayer housing closure relative to the sprayer housing in either of the first and second positions in accordance with the rotational position of the windshield wiper assembly.

There is also provided in accordance with a preferred embodiment of the present invention a method for windshield washing, which includes providing a windshield wiper assembly having mounted thereon a windshield sprayer assembly including at least one sprayer, including a sprayer housing and a sprayer housing closure movable relative to the sprayer housing, the sprayer housing closure providing a first position permitting spraying and a second position not permitting spraying, moving the windshield wiper assembly in rotational and linear motion along a vehicle windshield and selectably positioning the sprayer housing closure relative to the sprayer housing in either of the first and second positions in response to the linear motion of the windshield wiper assembly in accordance with the rotational position of the windshield wiper assembly.

Further in accordance with a preferred embodiment of the present invention the windshield wiper and sprayer assembly includes a base, which is arranged for rotation about a rotation axis.

Typically, the base is driven for reciprocating rotational motion by a conventional wiper drive assembly, forming part of a conventional motor vehicle.

Still further in accordance with a preferred embodiment of the present invention the windshield wiper and sprayer assembly includes a base mounted housing, which cooperates with the base and arranged for driven linear motion relative thereto.

Typically, the driven linear motion of the base mounted housing relative to the base is provided by a cam drive assembly.

Additionally in accordance with a preferred embodiment of the present invention the windshield wiper and sprayer assembly also includes a support arm, fixed to the base mounted housing for linear and rotational motion therewith.

Additionally or alternatively, the sprayer includes at least one heated to liquid sprayer, which undergoes linear and rotational motion together with the base mounted housing and which receives pressurized fluid for spraying via fluid conduits.

Further in accordance with a preferred embodiment of the present invention the windshield sprayer assembly positioning assembly includes an upstanding pin fixed to the base for rotary motion together therewith, the upstanding pin slidably engaging a base mounted housing slot formed in a bottom surface of the base mounted housing.

Preferably, the upstanding pin also slidingly engages an anchor element slot formed in an anchor element, which anchor element is linearly slidable relative to the base mounted housing and to the base along an axis generally parallel to the anchor element slot.

Additionally in accordance with a preferred embodiment of the present invention at least one compression wire is coupled to the anchor element and the at least one compression wire extends through at least one sleeve to the windshield sprayer assembly and being operative for controlling the positioning of the sprayer housing closure relative to the sprayer housing.

Typically, the windshield sprayer assembly includes a pressurized fluid chamber, which is defined between the sprayer housing and the sprayer housing closure, the pressurized fluid chamber receiving pressurized fluid to be sprayed from a fluid conduit via an inlet pipe.

Further in accordance with a preferred embodiment of the present invention the sprayer housing closure includes a cap which may be sealed and may be held tight against a corresponding sealing surface of the sprayer housing.

Still further in accordance with a preferred embodiment of the present invention the cap is arranged to be sealed and to be held tight by a spring loaded shaft assembly, which includes a compression spring.

Additionally in accordance with a preferred embodiment of the present invention the sprayer housing closure is normally positioned relative to the sprayer housing in the first position permitting spraying by operation of a spring loaded lever assembly, attached to an end of a compression wire.

Still further in accordance with a preferred embodiment of the present invention the spring loaded lever assembly includes a compression spring which normally urges a lever arm forward in engagement with a spring loaded shaft assembly, thereby overcoming the spring force of a further spring and urging the sprayer housing closure away from the sprayer housing.

Typically, the spring force of the further spring exceeds the spring force of the compression spring.

Additionally in accordance with a preferred embodiment of the present invention, when the base mounted housing is at an extreme inward radial orientation, the engagement of the upstanding pin at a radial outward end of the anchor element slot applies a compressive force to a compression wire, which compressive force is sufficient to overcome the spring force of the further spring and to force the lever arm to an orientation wherein it does not engage the spring loaded shaft assembly and does not overcome the spring force of the compression spring, thereby enabling the compression spring to seal the sprayer housing closure against the sprayer housing.

Still further in accordance with a preferred embodiment of the present invention, when base mounted housing is at the extreme inward radial orientation, both the anchor element and the base mounted housing are in their extreme retracted positions and a first separation is defined between an outward facing surface of the anchor element and an inner facing surface of the outer facing wall of the base mounted housing.

Further in accordance with a preferred embodiment of the present invention the base mounted housing moves radially outward from the extreme inward radial orientation, the anchor element is slidable relative to the base mounted housing and a second separation, greater than the first separation, is defined between an outward facing surface of the anchor element and an inner facing surface of the outer facing wall of the base mounted housing.

Preferably, the anchor element is slidable relative to the base mounted housing and moves radially outwardly together with the base mounted housing.

Further in accordance with a preferred embodiment of the present invention the pin engages the anchor element slot to provide a lost motion mechanism, whereby tensioning of the compression wires is avoided.

Still further in accordance with a preferred embodiment of the present invention the lost motion mechanism produces a liquid spray by allowing the pressurized fluid to escape from the pressurized fluid chamber.

Typically, the base mounted housing travels radially relative to the base.

Preferably, sufficient liquid pressure applied to the pressurized fluid chamber overcomes the spring force of the compression spring and permits spraying even when the sprayer housing is in the second position.

Additionally or alternatively, the sprayer at least one sprayer includes an electrical heating element for heating thereof.

Typically, the electrical heating element is coupled to a source of electrical power by an electrical conductor.

Still further in accordance with a preferred embodiment of the present invention the step for windshield spraying also includes receiving pressurized fluid into the at least one sprayer and spraying the pressurized fluid onto the vehicle windshield.

There is further provided in accordance with another preferred embodiment of the present invention a windshield sprayer assembly including at least one sprayer. The sprayer includes a sprayer housing, a sprayer housing closure arranged for selectable positioning relative to the sprayer housing and to assume a first position permitting spraying and a second position not permitting spraying and a heater heating the sprayer housing.

There is further provided in accordance with yet another preferred embodiment of the present invention a method for windshield spraying. The method includes providing at least one sprayer, including a sprayer housing and a sprayer housing closure arranged for selectable positioning relative to the sprayer housing and for assuming a first position permitting spraying and a second position not permitting spraying and heating the sprayer housing.

Further in accordance with a preferred embodiment of the present invention the heater includes an electric heater.

Additionally or alternatively, the heater includes a thermal heat exchange heater.

Still further in accordance with a preferred embodiment of the present invention the heater also heats the sprayer housing closure.

Additionally in accordance with a preferred embodiment of the present invention the heater is positioned near an end of the sprayer housing that is in contact with the sprayer housing closure when the sprayer housing closure is in the second position.

There is also provided in accordance with a preferred embodiment of the present invention a windshield washing system, which includes a windshield wiper and sprayer assembly including a windshield wiper assembly, a windshield wiper driver assembly operative to move the windshield wiper assembly in rotational motion along a vehicle windshield and a windshield sprayer assembly mounted on the windshield wiper assembly, the windshield sprayer assembly including at least one sprayer. The windshield sprayer assembly includes a sprayer housing and a sprayer housing closure arranged for selectable positioning relative to the sprayer housing and to assume a first position permitting spraying and a second position not permitting spraying. The windshield washing system also includes a windshield sprayer assembly positioning assembly operative in response to the rotational motion of the windshield wiper assembly for selectably positioning the sprayer housing closure relative to the sprayer housing in either of the first and second positions in accordance with the rotational position of the windshield wiper assembly.

There is further provided in accordance with a preferred embodiment of the present invention a method for windshield washing, which includes providing a windshield wiper assembly having mounted thereon a windshield sprayer assembly including at least one sprayer including a sprayer housing and a sprayer housing closure relative to the sprayer housing, the sprayer housing closure having a first position permitting spraying and a second position not permitting spraying, moving the windshield wiper assembly in rotational motion along a vehicle windshield and selectably positioning the sprayer housing closure relative to the sprayer housing in either of the first and second positions in accordance with the rotational position of the windshield wiper assembly.

Further in accordance with a preferred embodiment of the present invention the windshield wiper and sprayer assembly includes a base which is arranged for rotation about a rotation axis.

Preferably, the base is driven for reciprocating rotational motion by a conventional wiper drive assembly, forming part of a conventional motor vehicle.

Still further in accordance with a preferred embodiment of the present invention the windshield wiper and sprayer assembly includes a base mounted housing, cooperating with the base and arranged for rotational motion therewith.

Additionally in accordance with a preferred embodiment of the present invention the windshield sprayer assembly positioning assembly is responsive to the rotational position of the base for governing the relative position of the sprayer housing and the sprayer housing closure.

Further in accordance with a preferred embodiment of the present invention the windshield wiper and sprayer assembly also includes a support arm, fixed to the base mounted housing for rotational motion therewith.

Additionally or alternatively, the sprayer includes at least one heated liquid sprayer, which undergoes rotational motion together with the base mounted housing and which receives pressurized fluid for spraying via fluid conduits.

Still further in accordance with a preferred embodiment of the present invention the compression wire is coupled to at least one engagement element, the at least one compression wire extending through at least one sleeve to the windshield sprayer assembly and being operative for controlling the positioning of the sprayer housing closure relative to the sprayer housing.

Additionally in accordance with a preferred embodiment of the present invention the windshield sprayer assembly includes a pressurized fluid chamber, which is defined between the sprayer housing and the sprayer housing closure, the pressurized fluid chamber receives pressurized fluid to be sprayed from a fluid conduit via an inlet pipe.

Typically, the sprayer housing closure includes a cap which is arranged to be selectably sealed against a corresponding sealing surface of the sprayer housing.

Preferably, the cap may be sealed and may be held tight by a spring loaded shaft assembly, which includes a compression spring.

Further in accordance with a preferred embodiment of the present invention the sprayer housing closure is normally positioned relative to the sprayer housing in the first position permitting spraying.

Preferably, the sprayer housing closure is normally positioned relative to the sprayer housing in the first position permitting spraying by operation of a spring to loaded lever assembly, attached to an end of the compression wire.

Typically, the spring loaded lever assembly includes a compression spring which normally urges a lever arm forward in engagement with a spring loaded shaft assembly, thereby overcoming the spring force of a further spring and urging the sprayer housing closure away from the sprayer housing.

Further in accordance with a preferred embodiment of the present invention the spring force of the further spring exceeds the spring force of the compression spring.

Still further in accordance with a preferred embodiment of the present invention the windshield sprayer assembly positioning assembly includes push buttons which are arranged to be depressed by engagement with an engagement member when the windshield wiper assembly reaches an extreme position.

Additionally in accordance with a preferred embodiment of the present invention, when the windshield wiper assembly is at at least one extreme position, the engagement of the engagement member with the push buttons applies a compressive force to a compression wire, which compressive force is sufficient to overcome the spring force of the further spring and to force the lever arm to an orientation wherein it does not engage the spring loaded shaft assembly and does not overcome the spring force of the compression spring, thereby enabling the compression spring to seal the sprayer housing closure against sprayer housing.

Typically, sufficient liquid pressure is applied to the pressurized fluid chamber and overcomes the spring force of the compression spring and permits spraying even when the sprayer housing is in the second position.

Further in accordance with a preferred embodiment of the present invention the step for receiving pressurized fluid into the at least one sprayer and spraying the pressurized fluid onto the vehicle windshield.

There is also provided in accordance with another preferred embodiment of the present invention a liquid heating assembly, useful with a windshield wiper and sprayer assembly. The liquid heating assembly includes a housing defining a liquid heating chamber, a liquid heating volume defining subassembly disposed in the liquid heating chamber and including a base portion and a generally cylindrical wall portion which is provided with a plurality of liquid inlet apertures at various heights therealong.

There is further provided in accordance with a preferred embodiment of the present invention a method for heating liquid for use with a windshield wiper and sprayer assembly, which includes providing a housing defining a liquid heating chamber and disposing a liquid heating volume defining subassembly, including a base portion and a generally cylindrical wall portion, with a plurality of liquid inlet apertures at various heights along the wall portion, in the liquid heating chamber.

Further in accordance with a preferred embodiment of the present invention the liquid to be heated is received under pressure at an inlet and passes through a conduit into the liquid heating chamber and thence through the apertures into the liquid heating volume.

Still further in accordance with a preferred embodiment of the present invention the heated liquid exits at the top of the liquid heating chamber via a conduit and passes through a labyrinthine heating unit to an outlet.

Additionally in accordance with a preferred embodiment of the present invention the liquid to be heated is received under pressure at an inlet and passes through a conduit into the liquid heating chamber and thence into the liquid heating volume.

Further in accordance with a preferred embodiment of the present invention the liquid heating assembly also includes a pump, which is not part of the original equipment in a vehicle, which pressurizes liquid received via a conduit from a liquid reservoir, which is part of the original equipment of the vehicle.

Still further in accordance with a preferred embodiment of the present invention the liquid heating assembly further includes a pump, which pressurizes liquid received via a conduit from a liquid reservoir via a one-way valve.

Further in accordance with a preferred embodiment of the present invention the liquid heating assembly is arranged for retrofit installation into an existing motor vehicle.

Still further in accordance with a preferred embodiment of the present invention the liquid heating assembly also includes a first liquid temperature sensor located near the top of the liquid heating chamber and a second temperature sensor, which is located in a wall of the liquid heating chamber.

Typically, the second temperature sensor operates a circuit breaker switch, which is responsive to exceedance of a predetermined temperature threshold at the second temperature sensor for automatically interrupting the supply of electrical power from a vehicle battery to the liquid heating assembly.

There is further provided in accordance with yet another preferred embodiment of the present invention a liquid heating assembly useful with a windshield wiper and sprayer assembly. The liquid heating assembly includes a housing defining a liquid heating chamber, a liquid heating volume defining subassembly disposed in the liquid heating chamber and including a base portion and a generally cylindrical wall portion which is provided with at least one liquid inlet aperture and a labyrinthine heating unit receiving heated liquid from the liquid heating volume and providing further heated liquid to an outlet.

There is further provided in accordance with yet a further preferred embodiment of the present invention a method for heating liquid for use with a windshield wiper and sprayer assembly. The method includes providing a housing defining a liquid heating chamber, disposing a liquid heating volume defining subassembly, including a base portion and a generally cylindrical wall portion, including at least one liquid inlet aperture, in the liquid heating chamber, receiving heated liquid from the liquid heating volume into a labyrinthine heating unit, further heating the heated liquid and providing the further heated liquid from the labyrinthine heating unit to an outlet.

Further in accordance with a preferred embodiment of the present invention the liquid to be heated is received under pressure at an inlet and passes through a conduit into the liquid heating chamber and thence into the liquid heating volume.

Still farther in accordance with a preferred embodiment of the present invention the liquid heating assembly also includes a pump, which is not part of the original equipment in a vehicle, which pressurizes liquid received via a conduit from a liquid reservoir, which is part of the original equipment of the vehicle.

Additionally in accordance with a preferred embodiment of the present invention the liquid heating assembly further includes a pump, which pressurizes liquid received via a conduit from a liquid reservoir via a one-way valve.

There is further provided in accordance with yet a further embodiment of the present invention a liquid heating assembly useful with a windshield wiper and sprayer assembly. The liquid heating assembly includes a housing defining a liquid heating chamber, a liquid heating volume defining subassembly disposed in the liquid heating chamber and including a base portion and a generally cylindrical wall portion which is provided with at least one liquid inlet aperture and a pump, which is not part of the original equipment in a vehicle, which pressurizes liquid received via a conduit from a liquid reservoir, which is part of the original equipment of the vehicle.

There is also provided in accordance with another preferred embodiment a method for heating liquid useful with a windshield wiper and sprayer assembly. The method includes providing a housing defining a liquid heating chamber, disposing a liquid heating volume defining subassembly, including a base portion and a generally cylindrical wall portion, including at least one liquid inlet aperture, in the liquid heating chamber, receiving liquid via a conduit from a liquid reservoir, which is part of the original equipment of a vehicle and pressurizing the liquid with a pump, which is not part of the original equipment in the vehicle.

Further in accordance with a preferred embodiment of the present invention the liquid heating assembly is arranged for retrofit installation into an existing motor vehicle.

Still further in accordance with a preferred embodiment of the present invention the liquid heating assembly also includes a first liquid temperature sensor located near the top of the liquid heating chamber.

Additionally in accordance with a preferred embodiment of the present invention the liquid heating assembly further includes a second temperature sensor, which is located in a wall of the liquid heating chamber.

Typically, the second temperature sensor operates a circuit breaker switch, which is responsive to exceedance of a predetermined temperature threshold at the second temperature sensor for automatically interrupting the supply of electrical power from a vehicle battery to the liquid heating assembly.

There is still further provided in accordance with yet another preferred embodiment of the present invention a liquid heating assembly useful with a windshield wiper and sprayer assembly. The liquid heating assembly includes a housing defining a liquid heating chamber, a liquid heating volume defining subassembly disposed in the to liquid heating chamber and including a base portion and a generally cylindrical wall portion which is provided with at least one liquid inlet aperture and a temperature sensor located in a wall of the liquid heating chamber.

There is yet further provided in accordance with still another preferred embodiment of the present invention a method for heating liquid for use with a windshield wiper and sprayer assembly including providing a housing defining a liquid heating chamber, disposing a liquid heating volume defining subassembly, including a base portion and a generally cylindrical wall portion, including at least one liquid inlet aperture, in the liquid heating chamber, locating a temperature sensor in a wall of the liquid heating chamber and sensing temperature of the liquid via the temperature sensor.

Further in accordance with a preferred embodiment of the present invention the temperature sensor operates a circuit breaker switch, which is responsive to exceedance of a predetermined temperature threshold at the temperature sensor for automatically interrupting the supply of electrical power from a vehicle battery to the liquid heating assembly.

Still further in accordance with a preferred embodiment of the present invention the liquid heating assembly also includes electronic heating control circuitry.

Typically, the electronic heating control circuitry provides electrical power to at least one of first and second heating elements and a labyrinthine heating unit.

Preferably, the electronic heating control circuitry controls electrical power to at least one of the heating elements, thereby controlling spraying frequency.

Additionally in accordance with a preferred embodiment of the present invention the electronic heating control circuitry controls electrical power to at least two of the heating elements, thereby controlling spraying frequency.

Typically, the electronic heating control circuitry also provides electrical power to at least one pump which governs the supply of liquid under pressure to the liquid heating chamber.

Further in accordance with a preferred embodiment of the present invention the electronic heating control circuitry also provides at least one of electrical power and an electrical control signal to windshield wipers for producing reciprocating rotation thereof.

Still further in accordance with a preferred embodiment of the present invention the electronic heating control circuitry receives an input from an outside air temperature sensor.

Typically, the electronic heating control circuitry controls the operation of a labyrinthine heating unit in response to the outside air temperature sensor.

Additionally in accordance with a preferred embodiment of the present invention the electronic heating control circuitry receives an input from a dirt sensor for automatically initiating operation of the liquid heating assembly when a sprayable surface is dirty.

Preferably, the electronic heating control circuitry includes functionality for inhibiting operation of the liquid heating assembly, when the electric power status of the vehicle does not meet predetermined criteria.

Further in accordance with a preferred embodiment of the present invention the electronic heating control circuitry receives inputs from at least one of a battery voltage sensor, a battery charging current sensor and a vehicle engine rotation speed sensor.

Additionally or alternatively, the electronic heating control circuitry receives inputs from a battery voltage sensor, a battery charging current sensor and a vehicle engine rotation speed sensor.

Further in accordance with a preferred embodiment of the present invention the liquid heating also includes a circulation pump operative for circulating heated liquid from the liquid heating volume through circulation conduits to heat at least one of liquid sprayers, windshield wiper blades and heated liquid supply conduits.

Typically, the circulation pump is operated by the electronic heating control circuitry automatically in response to ambient outside temperatures.

Still further in accordance with a preferred embodiment of the present invention the liquid heating assembly further includes at least one operator control for providing at least one operating input to the electronic heating control circuitry.

Additionally in accordance with a preferred embodiment of the present invention the operator control communicates with the electronic heating control circuitry at least partially via existing wiring in a vehicle.

Typically, the operator control causes application of signal modulation to electrical power lines interconnecting a vehicle battery with the electronic heating control circuitry and wherein the electronic heating control circuitry includes functionality for decoding such signal modulation and employing it for controlling functions of the liquid heating assembly.

Preferably, the liquid heating assembly includes standby mode functionality.

Further in accordance with a preferred embodiment of the present invention the standby mode functionality is actuated at least one of automatically and by a vehicle operator using a standby mode actuation switch.

Still further in accordance with a preferred embodiment of the present invention the plurality of liquid inlet apertures are located at various azimuthal locations along the cylindrical wall portion.

Further in accordance with a preferred embodiment of the present invention the cylindrical wall portion also includes a slot.

Still further in accordance with a preferred embodiment of the present invention the liquid heating assembly operates in accordance with an operating protocol including the functional step of responding to a heated liquid spray demand signal, typically provided by a vehicle operator pushing a push button, associated with electronic heating control circuitry, operating at least a first heating element substantially continuously, thereby avoiding possible electrical interference resulting from high current switching.

Typically, the liquid heating assembly operates in accordance with an operating protocol and includes the additional functional steps of measuring the temperature at the outlet of the liquid heating chamber and causing the temperature at the outlet of the liquid heating chamber to reach a peak threshold value and then periodically varying between the peak threshold value and a somewhat lower threshold value.

Preferably, the functional step of causing the temperature at the outlet of the liquid heating chamber to reach a peak threshold value and then periodically to vary between the peak threshold value and a somewhat lower threshold value, corresponds to cycles of spraying heated liquid onto a vehicle windshield, which in turn corresponds to supplying of unheated liquid to the liquid heating chamber.

Further in accordance with a preferred embodiment of the present invention the liquid heating assembly operates in accordance with an operating protocol, which includes the following functional step of responding to a heated liquid spray demand signal, typically provided by a vehicle operator pushing a push button, associated with electronic heating control circuitry, operating at least a first and a second heating element substantially continuously, thereby avoiding possible electrical interference resulting from high current switching.

Still further in accordance with a preferred embodiment of the present invention the heating assembly operates in accordance with an operating protocol including the following additional functional steps of measuring the temperature at the outlet of the liquid heating chamber and causing the temperature at the outlet of the liquid heating chamber to reach a peak threshold value and then periodically to vary between the peak threshold value and a somewhat lower threshold value.

Preferably, the functional step of causing the temperature at the outlet of the liquid heating chamber to reach a peak threshold value and then periodically to vary between the peak threshold value and a somewhat lower threshold value, corresponds to cycles of spraying heated liquid onto a vehicle windshield, which in turn corresponds to supplying of unheated liquid to the liquid heating chamber.

Further in accordance with a preferred embodiment of the present invention the liquid heating assembly operates in accordance with an operating protocol including the following functional step of responding to a heated liquid spray demand signal, typically provided by a vehicle operator pushing a push button, associated with electronic heating control circuitry, operating at least a first and a second heating element and a labyrinthine heating unit substantially continuously, thereby avoiding possible electrical interference resulting from high current switching.

Preferably, the liquid heating assembly operates in accordance with an operating protocol including the following additional functional steps: measuring the temperature at the outlet of the liquid heating chamber, causing the temperature at the outlet of the liquid heating chamber to reach a peak threshold value and then periodically to vary between the peak threshold value and a somewhat lower threshold value.

Typically, the functional step of causing the temperature at the outlet of the liquid heating chamber to reach a peak threshold value and then periodically to vary between the peak threshold value and a somewhat lower threshold value, corresponds to cycles of spraying heated liquid onto a vehicle windshield, which in turn corresponds to supplying of unheated liquid to the liquid heating chamber.

Further in accordance with a preferred embodiment of the present invention the liquid heating assembly operates in accordance with an operating protocol including the following functional steps: responsive to a heated liquid spray demand signal, typically provided by a vehicle operator pushing a push button, associated with electronic heating control circuitry, operating at least a first heating element substantially continuously, thereby avoiding possible electrical interference resulting from high current switching and responsive to an immediate spray demand signal, provided by a vehicle operator actuating electronic heating control circuitry, providing a supply of pressurized liquid from the liquid heating chamber to the outlet, possibly even before commencement of operation of the at least first heating element.

Typically, the liquid heating assembly operates in accordance with an operating protocol including the following additional functional steps: measuring the temperature at the outlet of the liquid heating chamber and causing the temperature at the outlet of the liquid heating chamber to reach a peak threshold value and then periodically to vary between the peak threshold value and a somewhat lower threshold value.

Additionally in accordance with a preferred embodiment of the present invention the functional step of causing the temperature at the outlet of the liquid heating chamber to reach a peak threshold value and then periodically to vary between the peak threshold value and a somewhat lower threshold value, corresponds to cycles of spraying heated liquid onto a vehicle windshield, which in turn corresponds to supplying unheated liquid to the liquid heating chamber.

Further in accordance with a preferred embodiment of the present invention a labyrinthine heating unit is actuated prior to heated liquid spray demand signal.

Still further in accordance with a preferred embodiment of the present invention the labyrinthine heating unit is actuated upon ignition of a vehicle when the ambient outside temperature is below a threshold.

Further in accordance with a preferred embodiment of the present invention the peak threshold temperature varies in accordance with the boiling point of the spray liquid, thereby to provide efficient heating of the spray liquid without unnecessarily heating the liquid beyond its boiling point.

Additionally in accordance with a preferred embodiment of the present invention the electronic heating control circuitry is operative: to monitor the temperature of the spray liquid within the liquid heating, once a relatively stable temperature is reached during continuous operation of at least one heating element, indicating that the approximate boiling temperature has been reached to note that stable temperature and to set the peak temperature threshold to be below the sensed stable temperature, whereby the peak temperature threshold is a function of the composition of the spray liquid.

Further in accordance with a preferred embodiment of the present invention the standby mode functionality includes the following functional steps: upon vehicle ignition, the electronic heating control circuitry checks at least one of the following vehicle characteristics: vehicle battery voltage; vehicle battery charging current and vehicle engine rotation speed and compares them with predetermined minimum vehicle characteristic thresholds and if the minimum vehicle characteristic thresholds are met, a “GO” authorization is provided. Typically, the liquid heating assembly is operated in a standby mode as follows: if an outside temperature sensor is not available, the electronic heating control circuitry operates a labyrinthine heating unit and also operates at least one heating element in order to maintain the spray liquid in the liquid heating chamber at at least a first predetermined standby liquid temperature, if an outside temperature sensor is available, and the outside temperature measured thereby is greater than a first outside temperature threshold only the labyrinthine heating unit is operated, if the outside temperature measured by the outside temperature sensor is less than the first outside temperature threshold, but greater than a second outside temperature threshold, the labyrinthine heating unit is operated and at least one of the heating elements is additionally operated in order to maintain the liquid in the liquid heating chamber at at least a second predetermined standby liquid temperature and if the outside temperature measured by the outside temperature sensor is less than the second temperature threshold, the labyrinthine heating unit is operated and at least one of the heating elements is also operated in order to maintain the spray liquid at a third standby liquid temperature, greater than the first and second predetermined standby liquid temperatures.

Typically, the minimum vehicle characteristic thresholds are approximately as follows: vehicle battery voltage: 12.5 Volts, vehicle battery charging current: 15 Ampere and vehicle engine rotation speed: 1000 RPM.

There is also provided in accordance with yet another preferred embodiment of the present invention a heated liquid circulation system including a liquid heating assembly and a heated liquid circulation assembly for supplying heated liquid from the liquid heating assembly for circulation in thermal heat exchange engagement with at least one of a windshield wiper, a windshield sprayer and a liquid supply conduit for supplying liquid to the windshield sprayer.

There is further provided in accordance with another preferred embodiment of the present invention a heated liquid circulation method including heating a liquid and supplying the heated liquid for circulation in thermal heat exchange engagement with at least one of a windshield wiper, a windshield sprayer and a liquid supply conduit for supplying liquid to the windshield sprayer.

There is provided in accordance with yet a further embodiment of the present invention a heated liquid wiper and sprayer assembly, which includes a liquid heating assembly, at least one sprayer, a heated liquid supply assembly including at least one heated liquid supply conduit for supplying heated liquid from the liquid heating assembly to the at least one sprayer for spraying thereof, a heated liquid circulation assembly for supplying heated liquid from the liquid heating assembly for circulation in thermal heat exchange engagement with at least one of a windshield wiper, the at least one sprayer and to the at least one heated liquid supply conduit for heating thereof.

There is further provided in accordance with a preferred embodiment of the present invention a heated liquid wiper and sprayer method. The method includes heating a liquid, supplying heated liquid to at least one sprayer for spraying thereof, via at least one heated liquid supply conduit and circulating the heated liquid in thermal heat exchange engagement with at least one of a windshield wiper, the at least one sprayer and the at least one heated liquid supply conduit.

Further in accordance with a preferred embodiment of the present invention the heated liquid wiper and sprayer assembly also includes a windshield wiper assembly and a windshield wiper driver assembly operative to move the windshield wiper assembly in rotational and linear motion along a vehicle windshield, the at least one sprayer being mounted on the windshield wiper assembly.

Still further in accordance with a preferred embodiment of the present invention the windshield wiper assembly includes a base, which is arranged for rotation about a rotation axis.

Typically, the base is driven for reciprocating rotational motion by a conventional wiper drive assembly, forming part of a conventional motor vehicle.

Further in accordance with a preferred embodiment of the present invention the sprayer includes a sprayer housing and a sprayer housing closure arranged for selectable positioning relative to the sprayer housing and to assume a first position permitting spraying and a second position not permitting spraying.

Still further in accordance with a preferred embodiment of the present invention the heated liquid wiper and sprayer also includes a windshield sprayer assembly positioning assembly operative in response to the linear motion of the windshield wiper assembly for selectably positioning the sprayer housing closure relative to the sprayer housing in either of the first and second positions in accordance with the rotational position of the windshield wiper assembly.

Additionally in accordance with a preferred embodiment of the present invention the windshield wiper and sprayer assembly includes a base mounted housing, cooperating with the base and arranged for driven linear motion relative thereto.

Typically, the driven linear motion of the housing relative to the base is provided by a cam drive assembly.

Further in accordance with a preferred embodiment of the present invention the windshield wiper and sprayer assembly also includes a support arm, fixed to the housing for linear and rotational motion therewith.

Still further in accordance with a preferred embodiment of the present invention the sprayer includes at least one heated liquid sprayer, which undergoes linear and rotational motion together with the housing and which receives pressurized fluid for spraying via fluid conduits.

Additionally in accordance with a preferred embodiment of the present invention the windshield sprayer assembly positioning assembly includes an upstanding pin fixed to the base for rotary motion together therewith, the upstanding pin slidably engaging a base mounted housing slot formed in a bottom surface of the base mounted housing.

Typically, the upstanding pin also slidingly engages an anchor element slot formed in an anchor element, which anchor element is linearly slidable relative to the base mounted housing and to the base along an axis generally parallel to the anchor element slot.

Preferably, at least one compression wire is coupled to the anchor element. The one compression wire extends through at least one sleeve to the windshield sprayer assembly and controls the positioning of the sprayer housing closure relative to the sprayer housing.

Further in accordance with a preferred embodiment of the present invention the sprayer assembly includes a pressurized fluid chamber, which is defined between the sprayer housing and the sprayer housing closure, the pressurized fluid chamber receiving pressurized fluid to be sprayed from a fluid conduit via an inlet pipe.

Typically, the sprayer housing closure includes a cap which is selectably sealed against a corresponding sealing surface of the sprayer housing.

Preferably, the cap is selectably sealed by a spring loaded shaft assembly, which includes a compression spring.

Additionally in accordance with a preferred embodiment of the present invention the sprayer housing closure is normally positioned relative to the sprayer housing in the first position permitting spraying.

Typically, the sprayer housing closure is normally positioned by operation of a spring loaded lever assembly, attached to an end of a compression wire.

Typically, the spring loaded lever assembly includes a compression spring which normally urges a lever arm forward in engagement with a spring loaded shaft assembly, thereby overcoming the spring force of a further spring and urging the sprayer housing closure away from the sprayer housing.

Additionally in accordance with a preferred embodiment of the present invention the spring force of the further spring exceeds the spring force of the compression spring.

Further in accordance with a preferred embodiment of the present invention, when the housing is at an extreme inward radial orientation, the compression spring is enabled to seal the sprayer housing closure against sprayer housing.

Typically, the engagement of the upstanding pin at a radial outward end of the anchor element slot applies a compressive force to a compression wire, which compressive force is sufficient to overcome the spring force of the further spring and to force the lever arm to an orientation wherein it does not engage the spring loaded shaft assembly and does not overcome the spring force of the compression spring.

Preferably, when the base mounted housing is at the extreme inward radial orientation, both the anchor element and the base mounted housing are in their extreme retracted positions and a first separation is defined between an outward facing surface of the anchor element and an inner facing surface of the outer facing wall of the base mounted housing.

Further in accordance with a preferred embodiment of the present invention the liquid heating assembly includes a housing defining a liquid heating chamber, a liquid heating volume defining subassembly disposed in the liquid heating chamber and including a base portion and a generally cylindrical wall portion which is provided with at least one liquid inlet aperture and a labyrinthine heating unit receiving heated liquid from the liquid heating volume and providing further heated liquid to an outlet.

Typically, the liquid to be heated is received under pressure at an inlet and passes through a conduit into the liquid heating chamber and thence into the liquid heating volume.

Still further in accordance with a preferred embodiment of the present invention the liquid heating assembly also includes a pump, which is not part of the original equipment in the vehicle, which pressurizes the liquid received via a conduit from a liquid reservoir, which is part of the original equipment of the vehicle.

Further in accordance with a preferred embodiment of the present invention the also includes a pump, which pressurizes liquid received via a conduit from a liquid reservoir via a one-way valve.

Typically, the liquid heating assembly is arranged for retrofit installation into an existing motor vehicle.

Additionally in accordance with a preferred embodiment of the present invention the heated liquid wiper and sprayer assembly also includes a first liquid temperature sensor located near the top of the liquid heating chamber.

Still further in accordance with a preferred embodiment of the present invention the liquid heating assembly also includes a second temperature sensor which is located in a wall of the liquid heating chamber.

Further in accordance with a preferred embodiment of the present invention the second temperature sensor operates a circuit breaker switch, which is responsive to exceedance of a predetermined temperature threshold at the second temperature sensor for automatically interrupting the supply of electrical power from a vehicle battery to the liquid heating assembly.

Typically, heated liquid from the liquid heating assembly is circulated alongside the heated liquid supply conduit and through the at least one sprayer by a circulating pump cooperating with a pair of circulation conduits, which are joined at the at least one sprayer to define a continuous circulation path.

Preferably, the circulation conduits and the liquid supply conduit are defined in a unitary conduit.

Typically, the circulation conduits generally surround the heated liquid supply conduit for efficient heat transfer therewith.

Further in accordance with a preferred embodiment of the present invention the sprayer is formed with an internal liquid circulation path to which the circulation conduits are coupled. The liquid circulation path surrounds a heated spray liquid pathway which couples the heated liquid supply conduit to a spray head.

Typically, upon initiation of a heated spray operation by a vehicle operator, the circulating pump is immediately actuated to begin circulating liquid from the liquid heating assembly, thus monotonically heating both the at least one sprayer and liquid in the heated liquid supply conduit, such that the liquid in the heated liquid supply conduit, when sprayed, is heated to a temperature above the ambient.

Further in accordance with a preferred embodiment of the present invention the sprayer includes a sealed volume which receives spray liquid under pressure from the supply conduit at an inlet and is provided with a plurality of spray outlets for spraying the liquid under pressure onto a vehicle windshield and an internal heat exchanging liquid circulation pathway element, disposed within the sealed volume and coupled to the heated liquid circulation assembly.

Additionally in accordance with a preferred embodiment of the present invention the windshield wiper assembly includes a wiper blade formed with an internal heat exchanging liquid circulation pathway element coupled to the heated liquid circulation assembly.

Further in accordance with a preferred embodiment of the present invention the heated liquid wiper and sprayer method also includes receiving pressurized fluid into the sprayer and spraying the pressurized fluid onto the vehicle windshield.

There is also provided in accordance with another preferred embodiment of the present invention a windshield sprayer controlling system, which includes a windshield wiper assembly, including a windshield wiper support arm and a windshield wiper, a windshield wiper driver assembly, which operates to move the windshield wiper assembly in rotational motion along a vehicle windshield and at least one windshield sprayer mounted on the windshield wiper assembly. The support arm controls the windshield sprayer in accordance with the direction of movement of the wiper assembly relative to the windshield.

There is further provided in accordance with another preferred embodiment of the present invention a windshield sprayer controlling method. The method includes providing a windshield wiper assembly including a windshield wiper support arm and a windshield wiper with at least one windshield sprayer mounted thereon, moving the windshield wiper assembly in rotational motion along a vehicle windshield and controlling the at least one windshield sprayer in accordance with the direction of movement of the wiper assembly relative to the windshield.

Further in accordance with a preferred embodiment of the present invention the windshield sprayer controlling system also includes at least one second windshield sprayer mounted on the windshield wiper assembly, the support arm controlling the second windshield sprayer in accordance with the direction of movement of the wiper assembly relative to the windshield.

Still further in accordance with a preferred embodiment of the present invention the windshield sprayer controlling system according also includes at least one liquid supply conduit supplying liquid to the at least one windshield sprayer.

Additionally in accordance with a preferred embodiment of the present invention the windshield sprayer controlling system also includes one liquid supply conduit supplying liquid the windshield sprayer.

Moreover in accordance with a preferred embodiment of the present invention the windshield sprayer controlling system further includes one liquid supply conduit supplying liquid to at least one windshield sprayer and to at least one second windshield sprayer.

Typically, the support arm also includes a control mechanism.

Preferably, the control mechanism is located near an end of the support arm.

Further in accordance with a preferred embodiment of the present invention the control mechanism is loosely pivotably mounted onto an end portion of the support arm generally along a first axis and includes a wiper blade which may be slidably and removably mounted within a track support element. The track support element is integrally formed with a pair of side attachment walls which are formed with aligned apertures through which extends an axle which extends generally along the first axis. This allows the windshield wiper assembly to pivot about the first axis in a conventional manner, wherein the loose mounting of the windshield wiper assembly onto the end portion also allows pivoting of the track support element relative to the end portion about a pivot axis, which intersects the first axis, wherein the pivoting about the pivot axis is employed to direct liquid to one or more of the sprayers in accordance with the direction of movement of the windshield wiper assembly at any given instant.

Typically, the end portion of the support arm, which ties in a plane generally perpendicular to the surface of the windshield.

Still further in accordance with a preferred embodiment of the present invention the end portion is formed with at least one engagement surface which can be brought into liquid flow interrupting operative engagement with one of two liquid conduits, which receive pressurized liquid via the supply conduit, thereby interrupting liquid flow therethrough.

There is also provided in accordance with another preferred embodiment of the present invention a heated liquid spray system for vehicles, which includes a windshield washing subsystem. The windshield washing subsystem includes a windshield wiper and sprayer assembly including a windshield wiper assembly, a windshield wiper driver assembly operative to move the windshield wiper assembly in rotational and linear motion along a vehicle windshield, a windshield sprayer assembly mounted on the windshield wiper assembly. The windshield sprayer assembly includes at least one sprayer and the sprayer includes a sprayer housing and a sprayer housing closure arranged for selectable positioning relative to the sprayer housing and to assume a first position permitting spraying and a second position not permitting spraying. The windshield wiper and sprayer assembly also includes a windshield sprayer assembly positioning assembly which operates in response to the linear motion of the windshield wiper assembly for selectably positioning the housing closure relative to the housing in either of the first and second positions in accordance with the rotational position of the windshield wiper assembly. The heated liquid spray system further includes a liquid heating assembly subsystem, which includes a housing defining a liquid heating chamber and a liquid heating volume defining subassembly disposed in the liquid heating chamber and includes a base portion and a generally cylindrical wall portion which is provided with at least one liquid inlet aperture.

There is further provided in accordance with another preferred embodiment of the present invention a heated liquid spray method for vehicles. The method includes providing a windshield wiper assembly having mounted thereon a windshield sprayer assembly including at least one sprayer including a sprayer housing and a sprayer housing closure movable relative to the sprayer housing, the sprayer housing closure providing a first position permitting spraying and a second position not permitting spraying, moving the windshield wiper assembly in rotational and linear motion along a vehicle windshield, selectably positioning the sprayer housing closure relative to the sprayer housing in either of the first and second positions in response to the linear motion of the windshield wiper assembly in accordance with the rotational position of the windshield wiper assembly, providing a liquid heating chamber, disposing a liquid heating volume defining subassembly, including a base portion and a generally cylindrical wall portion, including at least one liquid inlet aperture, in the liquid heating chamber and supplying heated liquid from the liquid heating chamber to the sprayer.

There is further provided in accordance with yet another preferred embodiment of the present invention a heated liquid spray system for vehicles, which includes a windshield washing subsystem. The windshield washing subsystem includes a windshield wiper and sprayer assembly including a windshield wiper assembly, a windshield wiper driver assembly operative to move the windshield wiper assembly in at least rotational motion along a vehicle windshield, a windshield sprayer assembly mounted on the windshield wiper assembly. The windshield sprayer assembly includes at least one sprayer, including a sprayer housing and a sprayer housing closure arranged for selectable positioning relative to the sprayer housing and to assume a first position permitting spraying and a second position not permitting spraying. The windshield wiper and sprayer assembly also includes a windshield sprayer assembly positioning assembly operative in response to the motion of the windshield wiper assembly for selectably positioning the housing closure relative to the housing in either of the first and second positions in accordance with the rotational position of the windshield wiper assembly. The heated liquid spray system also includes a liquid heating assembly subsystem and the liquid heating assembly subsystem includes a housing defining a liquid heating chamber and a liquid heating volume defining subassembly disposed in the liquid heating chamber and including a base portion and a generally cylindrical wall portion which is provided with at least one liquid inlet aperture.

There is also provided in accordance with yet another preferred embodiment of the present invention a heated liquid spray method for vehicles. The method includes providing a windshield wiper assembly having mounted thereon a windshield sprayer assembly including at least one sprayer including a sprayer housing and a sprayer housing closure movable relative to the sprayer housing, the sprayer housing closure providing a first position permitting spraying and a second position not permitting spraying, moving the windshield wiper assembly in at least rotational motion along a vehicle windshield, selectably positioning the sprayer housing closure relative to the sprayer housing in either of the first and second positions in response to the linear motion of the windshield wiper assembly in accordance with the rotational position of the windshield wiper assembly, providing a liquid heating chamber, disposing a liquid heating volume defining subassembly, including a base portion and a generally cylindrical wall portion, including at least one liquid inlet aperture, in the liquid heating chamber and supplying heated liquid from the liquid heating chamber to the sprayer.

There is also provided in accordance with yet another preferred embodiment of the present invention a heated liquid spray system for vehicles, which includes a windshield washing subsystem. The windshield washing subsystem includes a windshield wiper and sprayer assembly, which includes a windshield wiper assembly, a windshield wiper driver assembly operative to move the windshield wiper assembly in at least rotational motion along a vehicle windshield, a windshield sprayer assembly mounted on the windshield wiper assembly, the windshield sprayer assembly including at least one sprayer. The sprayer includes a sprayer housing and a sprayer housing closure arranged for selectable positioning relative to the sprayer housing and to assume a first position permitting spraying and a second position not permitting spraying. The windshield wiper and sprayer assembly also includes a windshield sprayer assembly positioning assembly operative in response to the motion of the windshield wiper assembly for selectably positioning the housing closure relative to the housing in either of the first and second positions in accordance with the rotational position of the windshield wiper assembly. The heated liquid spray system also includes a liquid heating assembly subsystem. The liquid heating subsystem includes a housing defining a liquid heating chamber, a liquid heating volume defining subassembly disposed in the liquid heating chamber and a labyrinthine heating unit receiving heated liquid from the liquid heating volume and providing further heated liquid to an outlet.

There is also provided in accordance with yet another preferred embodiment of the present invention a heated liquid spray method for vehicles. The method includes providing a windshield wiper assembly having mounted thereon a windshield sprayer assembly including at least one sprayer including a sprayer housing and a sprayer housing closure movable relative to the sprayer housing, the sprayer housing closure providing a first position permitting spraying and a second position not permitting spraying, moving the windshield wiper assembly in rotational and linear motion along a vehicle windshield, selectably positioning the sprayer housing closure relative to the sprayer housing in either of the first and second positions in response to the linear motion of the windshield wiper assembly in accordance with the rotational position of the windshield wiper assembly, providing a liquid heating chamber, disposing a liquid heating volume defining subassembly, including a base portion and a generally cylindrical wall portion, including at least one liquid inlet aperture, in the liquid heating chamber, receiving heated liquid from the liquid heating volume into a labyrinthine heating unit, further heating the heated liquid and providing the further heated liquid from the labyrinthine heating unit to the sprayer.

Further in accordance with a preferred embodiment of the present invention the heated liquid wiper and sprayer assembly also includes a heated liquid circulation assembly subsystem for supplying heated liquid from the liquid heating chamber for circulation in thermal heat exchange engagement with at least one of a windshield wiper, the at least one sprayer and the at least one heated liquid supply conduit, for heating thereof.

### BRIEF DESCRIPTION OF THE DRAWINGS

The present invention will be understood and appreciated more fully from the following detailed description, taken in conjunction with the drawings in which:

FIGS. 1A, 1B and 1C are simplified illustrations of a windshield wiper and sprayer assembly constructed and operative in accordance with a preferred embodiment of the present invention, in a first operative orientation, FIG. 1A being a partially cut-away pictorial illustration and FIGS. 1B and 1C being sectional illustrations taken along lines IB-IB and IC-IC in FIG. 1A, respectively;

FIGS. 2A, 2B and 2C are simplified illustrations of the windshield wiper and sprayer assembly of FIGS. 1A-1C in a second operative orientation, FIG. 2A being a partially cut-away pictorial illustration and FIGS. 2B and 2C being sectional illustrations taken along lines IIB-IIB and IIC-IIC in FIG. 2A, respectively;

FIGS. 3A, 3B and 3C are simplified illustrations of the windshield wiper and sprayer assembly of FIGS. 1A-1C in a third operative orientation, FIG. 3A being a partially cut-away pictorial illustration and FIGS. 3B and 3C being sectional illustrations taken along lines IIIB-IIIB and IIIC-IIIC in FIG. 3A, respectively;

FIG. 4A is a simplified illustration of the windshield wiper and sprayer assembly of FIGS. 1A-3C in various operative orientations in accordance with a preferred embodiment of the present invention;

FIG. 4B is a simplified illustration of a variation of the windshield wiper and sprayer assembly of FIGS. 1A-3C in various operative orientations in accordance with a preferred embodiment of the present invention;

FIGS. 5A and 5B are simplified illustrations of a windshield wiper and sprayer assembly constructed and operative in accordance with another preferred embodiment of the present invention, in a first operative orientation, FIG. 5A being a partially cut-away pictorial illustration and FIG. 5B being a sectional illustration taken along lines VB-VB in FIG. 5A;

FIGS. 6A and 6B are simplified illustrations of the windshield wiper and sprayer assembly of FIGS. 5A and 5B in a second operative orientation, FIG. 6A being a partially cut-away pictorial illustration and FIG. 6B being a sectional illustration taken along lines VIB-VIB in FIG. 6A;

FIG. 7A is a simplified illustration of the windshield wiper and sprayer assembly of FIGS. 5A and 6B in various operative orientations in accordance with a preferred embodiment of the present invention;

FIG. 7B is a simplified illustration of a variation of the windshield wiper and sprayer assembly of FIGS. 5A and 6B in various operative orientations in accordance with another preferred embodiment of the present invention;

FIG. 8 is a simplified sectional illustration of a liquid heating assembly useful with the windshield wiper and sprayer assemblies of FIGS. 1A-7B, constructed and operative in accordance with a preferred embodiment of the present invention; embodiments of a cylindrical wall portion of a liquid heating volume defining subassembly employed in the liquid heating assembly of FIG. 8;

FIGS. 10A, 10B, 10C, 10D, 10E and 10F are simplified timing diagrams illustrating various modes of operation of the liquid heating assembly of FIG. 8;

FIG. 11 is a simplified partially pictorial illustration of a windshield wiper and sprayer assembly constructed and operative in accordance with another preferred embodiment of the present invention;

FIGS. 12A and 12B are sectional illustrations taken along respective lines XIIA-XIIA and XIIB-XIIB in FIG. 11;

FIG. 13 is a simplified partially pictorial illustration of a windshield wiper and sprayer assembly constructed and operative in accordance with yet another preferred embodiment of the present invention;

FIG. 14 is a simplified partially pictorial illustration of a windshield wiper and sprayer assembly constructed and operative in accordance with still another preferred embodiment of the present invention;

FIGS. 15A and 15B are sectional illustrations taken along respective lines XVA-XVA and XVB-XVB in FIG. 14;

FIGS. 16A and 16B, 17A and 17B and 18A and 18B are illustrations of a windshield wiper and sprayer assembly having a wiping direction responsive spray functionality constructed and operative in accordance with a preferred embodiment of the present invention; and

FIG. 19 is a simplified flow chart illustration of standby operation of the liquid heating assembly of FIG. 8.

### DETAILED DESCRIPTION OF PREFERRED EMBODIMENTS

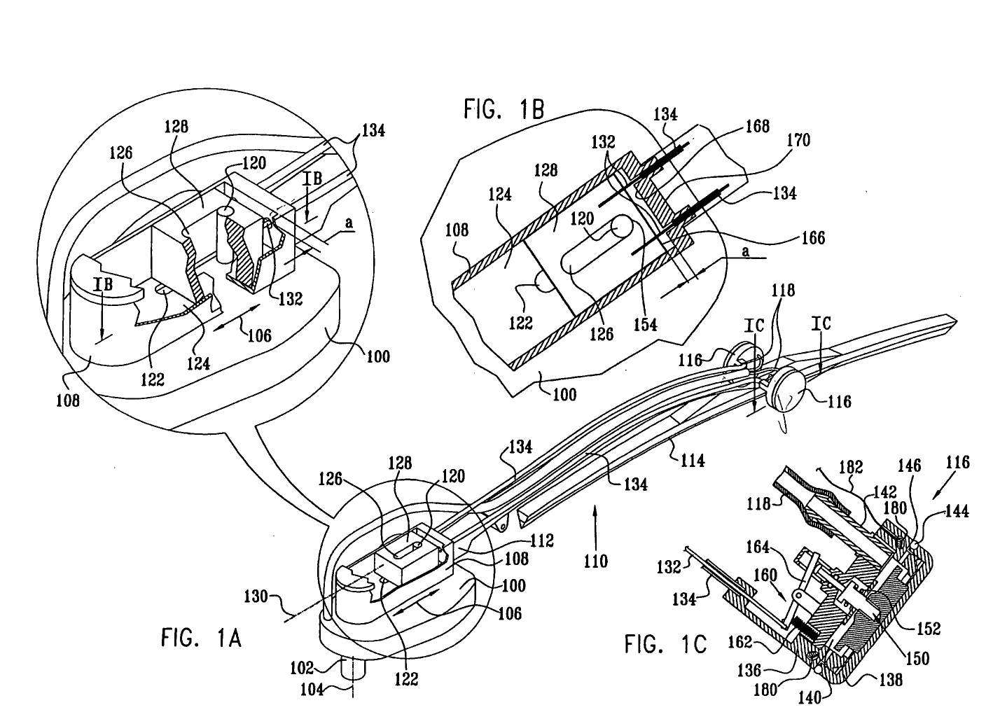

Reference is now made to FIGS. 1A, 1B and 1C; 2A, 2B and 2C and 3A, 3B and 3C, which are simplified illustrations of a windshield wiper and sprayer assembly constructed and operative in accordance with a preferred embodiment of the present invention, in closed and open operative orientations, FIGS. 1A, 2A and 3A being partially cut-away pictorial illustrations and FIGS. 1B, 2B and 3B and 1C, 2C and 3C being sectional illustrations taken along lines IB-MB and IC-IC, IIB-IIB and IIC-IIC and IIB-IIB and IIIC-IIIC, respectively.

For the purpose of this patent application the term “windshield” is given a broader meaning than usual and refers to any window, mirror or headlight surface of a vehicle.

As seen in FIGS. 1A-1C, 2A-2C and 3A-3C, the windshield wiper and sprayer assembly comprises a base 100 which is fixed to a shaft 102 which is arranged for rotation about a rotation axis 104. Shaft 102 is preferably driven for reciprocating rotational motion by a conventional wiper drive assembly (not shown), forming part of a conventional motor vehicle.

Cooperating with base 100 and arranged for driven linear motion relative thereto, as indicated by arrows 106, is a housing 108. The linear motion of base mounted housing 108 relative to base 100 preferably has a maximum amplitude of approximately 70 mm. This linear motion is preferably provided by a cam drive assembly (not shown). Suitable drive assemblies of this type are commercially available on windshield wiper assemblies installed as original equipment on Mercedes-Benz automobiles, such as Model No. 220C.

Fixed to base mounted housing 108 for linear and rotational motion therewith is a windshield wiper and heated liquid sprayer assembly 110 including a support arm 112 mounted onto housing 108. Assembly 110 preferably includes a windshield wiper assembly 114 and a pair of heated liquid spray assemblies 116, all of which undergo linear and rotational motion together with housing 108. Spray assemblies 116 receive pressurized fluid for spraying via fluid conduits 118.

Also fixed to base 100 for rotary motion together therewith is an upstanding pin 120, which slidably engages a base mounted housing slot 122 formed in a bottom surface 124 of base mounted housing 108. In the illustrated embodiment, base mounted housing slot 122 is at least approximately 70 mm. in length. Pin 120 also slidingly engages an anchor element slot 126 in an anchor element 128. Anchor element 128 is preferably linearly slidable relative to base mounted housing 108 and to base 100 along an axis 130 parallel to arrows 106 and parallel to base mounted housing slot 122.

Coupled to anchor element 128 are a pair of compression wires 132 which extend through respective coaxial sleeves 134 to respective normally open spray assemblies 116 and are operative for controlling the closing and opening of the spray assemblies.

Referring particularly to FIGS. 1C, 2C and 3C, it is seen that spray assemblies 116 each comprise a sprayer housing 136 and a cap portion 138 which is selectably closed by the action of compression wires 132.

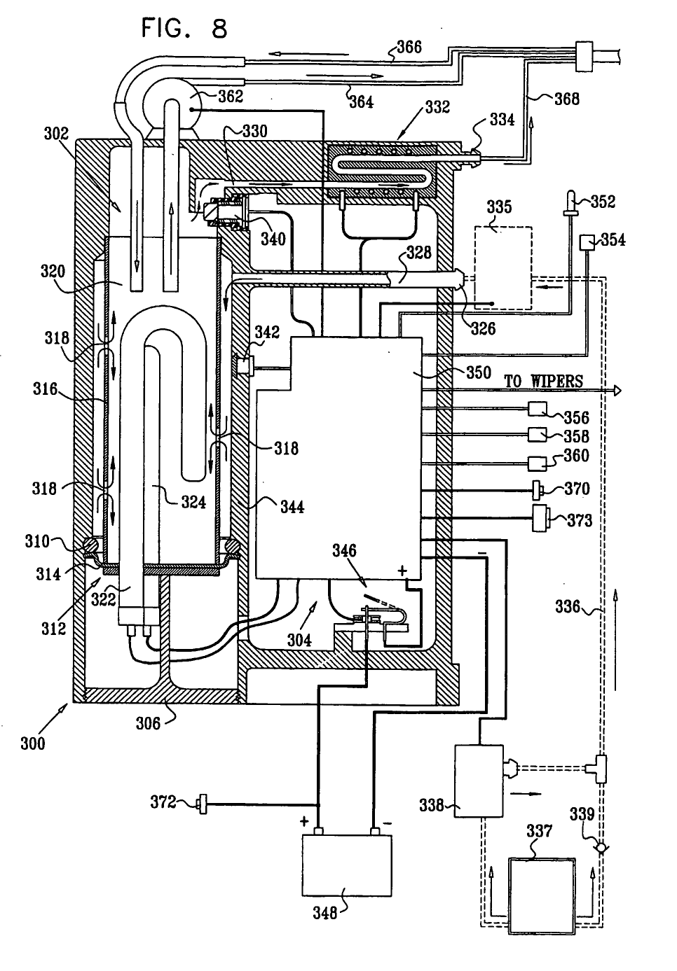

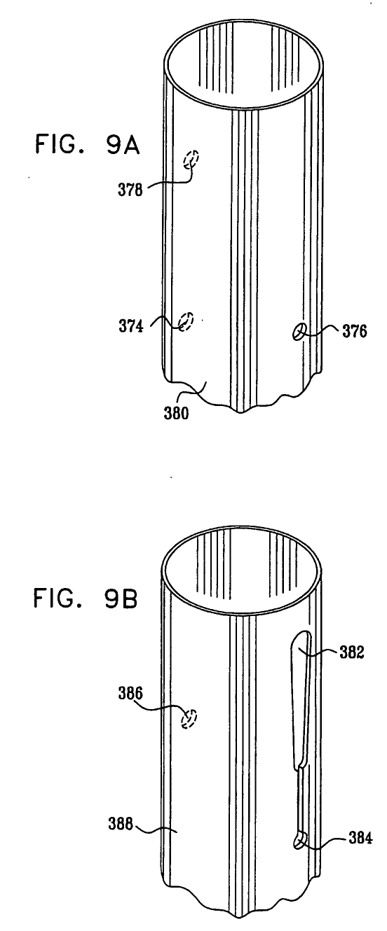

In the preferred embodiment of the invention illustrated in FIGS. 1C, 2C and 3C, it is seen that a pressurized fluid chamber 140 is defined between the sprayer housing 136 and the cap 138 and receives pressurized fluid to be sprayed from the fluid conduit 118 via an inlet pipe 142. The cap 138 may be sealed, preferably by means of an O-ring 144, and may be held tight against a corresponding sealing surface 146 of sprayer housing 136 by a spring loaded shaft assembly 150, which includes a compression spring 152. The sealing of the cap 138 typically prevents evaporation of the liquid, penetration of dirt into the liquid spray assemblies 116 and return of the liquid from the resevoir 337, as described hereinbelow with respect to FIG. 8.

As noted above, each spray assembly 116 is normally open. This normally open state is the result of the action of the spring loaded lever assembly 160, attached to an end of each compression wire 132. Spring loaded lever assembly 160 preferably comprises a compression spring 162 which normally urges a lever arm 164 to engage spring loaded shaft assembly 150, thereby overcoming the spring force of spring 152 and urging the cap 138 away from sprayer housing 136. In the illustrated embodiment, the spring force of compression spring 162 exceeds that of compression spring 152.

FIGS. 1A-1C show base mounted housing 108 and windshield wiper and heated liquid sprayer assembly 110 at extreme inward radial orientations. In this orientation, the engagement of pin 120 at the radial outward end 154 of anchor element slot 126 in anchor element 128 applies a compressive force to compression wires 132 sufficient to overcome the spring force of compression spring 162 and to force lever arm 164 to an orientation wherein it does not engage spring loaded shaft assembly 150 and does not overcome the spring force of spring 152. Spring 152 thus seals cap 138 against sprayer housing 136, as shown in FIG. 1C.

In this operative orientation, as seen in FIG. 1B, both anchor element 128 and base mounted housing 108 are in their extreme retracted positions and a separation “a” is defined between the outward facing surface 166 of anchor element 128 and the inner facing surface 168 of the outer facing wall 170 of base mounted housing 108.

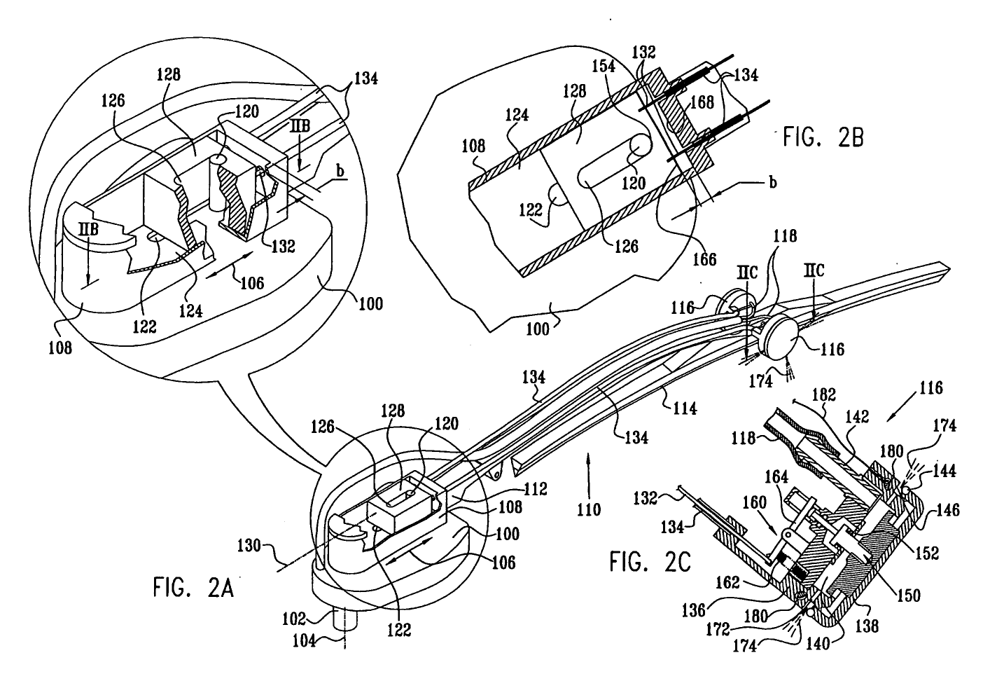

Upon initial radial outward movement of housing 108, support arm 112 and spray assemblies 116, inasmuch as anchor element 128 is slidable relative to the base mounted housing 108, it need not and does not move radially outwardly together with housing 108 and thus the separation “a” in FIG. 1B increases to “b”, as shown in FIG. 2B.

As seen in FIGS. 2A, 2B and 2C, pin 120 remains in engagement with the radial outward end of slot 154 in anchor element 128, while base mounted housing 108 and the spray assemblies 116 move radially outwardly. This reduces or eliminates the compressive force to compression wires 132 and enables compression spring 162 to extend and to force lever arm 164 to an orientation wherein it engages spring loaded shaft assembly 150, thereby overcoming the spring force of spring 152 and urging the cap 138 away from sprayer housing 136 as shown in FIG. 2C, thereby allowing pressurized liquid to escape from pressurized fluid chamber 140 via conduits 172 and to produce a liquid spray 174.

Typically the amount of radial travel of housing 108 between the orientations of FIGS. 1A-1C and FIGS. 2A-2C relative to base 100 is approximately 5 mm. In the illustrated embodiment, the orientation of lever arm 164 is such that the resulting closed to open travel of cap portion 138 relative to housing portion 136 is also approximately 5 mm.

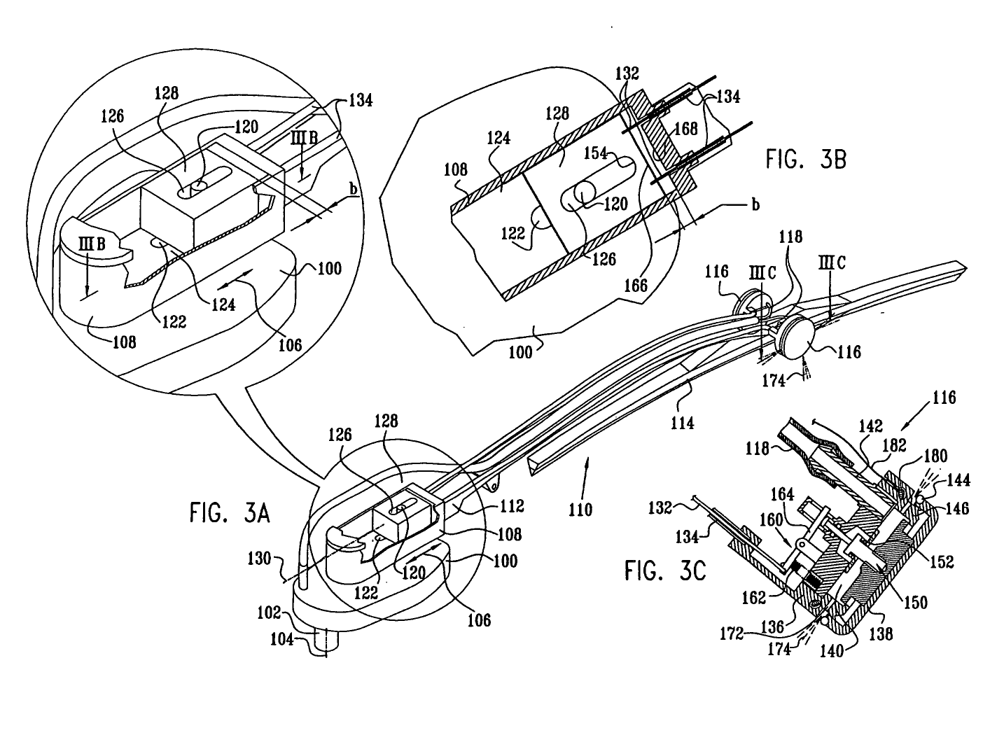

Upon further radial outward movement of housing 108, support arm 112 and spray assemblies 116, notwithstanding that anchor element 128 is slidable relative to the housing 108, it moves radially outwardly together with base mounted housing 108. As seen in FIGS. 3A, 3B and 3C, pin 120 remains in engagement with slot 126 in anchor element 128, but its position along that slot changes to the extent of the further radial outward movement, as base mounted housing 108 and the spray assemblies 116 move radially outwardly. The engagement of pin 120 with anchor element slot 126 thus may be appreciated to provide a lost motion mechanism, whereby tensioning of compression wires 132 is avoided, while maintaining the distance “b” between the outward facing surface 166 and the inner facing surface 168.

During this further radial outward movement of base mounted housing 108, compression wires 132 remain generally unstressed and compression spring 162 remains extended and continues to force lever arm 164 to an orientation wherein it engages spring loaded shaft assembly 150, thereby overcoming the spring force of spring 152 and urging the cap 138 away from sprayer housing 136 as shown in FIG. 3C, thereby allowing pressurized liquid to escape from pressurized fluid chamber 140 via conduits 172 and to produce a liquid spray 174.

Typically the amount of radial travel of housing 108 relative to base 100, between the orientations of FIGS. 2A-2C and FIGS. 3A-3C, is approximately 65 mm. In the illustrated embodiment, the orientation of lever arm 164 is such that no further travel of cap portion 138 relative to housing portion 136 takes place.

It is a particular feature of the invention that even when the spray assembly 116 is in its closed position, sufficient liquid pressure applied to chamber 140 may overcome the spring force of spring 152 and permit spraying.

It is appreciated that the spray assemblies 116 may be heated by an electrical heating element 180 which may be coupled by an electrical conductor 182 to a source of electrical power (not shown). It is appreciated that the heating of the spray assembly 116 may also allow for the melting of ice, which may form around the spray assembly 116.

It is also apprecaited that other forms of heating the spray assembly 116 may be used.

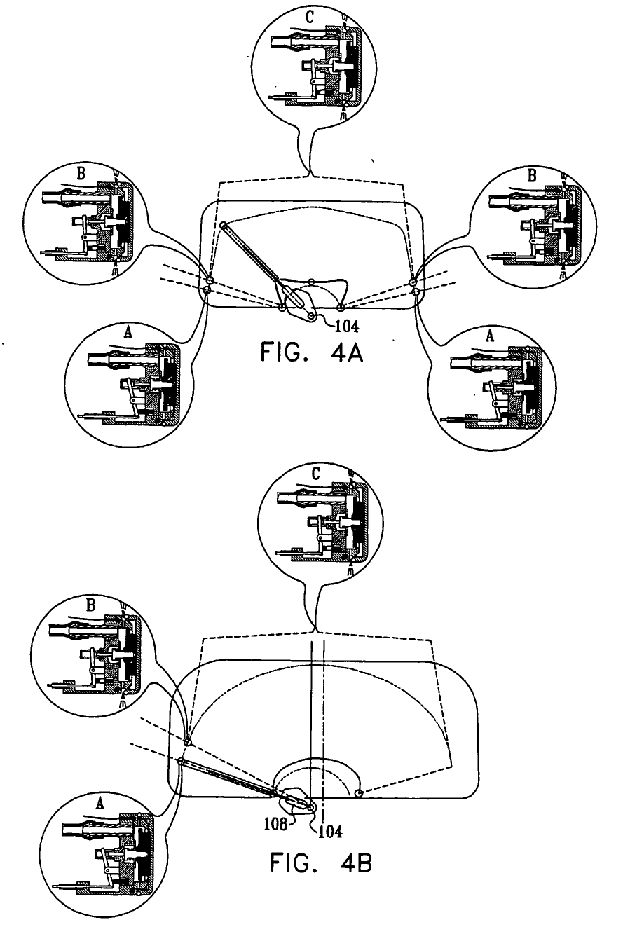

Reference is now made to FIG. 4A, which is a simplified illustration of the windshield wiper and sprayer assembly of FIGS. 1A-3C in various operative orientations in accordance with a preferred embodiment of the present invention. As seen in FIG. 4A, the orientations indicated by A correspond to the orientations shown in FIGS. 1A-1C, the orientations indicated by B correspond to the orientations shown in FIGS. 2A-2C and the range of orientations indicated by C correspond to the orientations shown in FIG. 3C.

Reference is now made to FIG. 4B, which is a simplified illustration of a variation of the windshield wiper and sprayer assembly of FIGS. 1A-3C in various operative orientations in accordance with a preferred embodiment of the present invention. The embodiment of FIG. 4B differs from that of FIG. 4A in that the location of rotation axis 104 (FIG. 1A) is slightly shifted to the side of the windshield, as compared to its location in the embodiment of FIG. 4A. The pattern of radial outward travel of housing 108 (FIG. 1A) produced by the cam drive assembly (not shown) is accordingly somewhat different.

In FIG. 4B, the orientation indicated by A corresponds to the orientations shown in FIGS. 1A-1C; the orientations indicated by B correspond to the orientations shown in FIGS. 2A-2C and the range of orientations indicated by C correspond to the orientations shown in FIG. 3C.

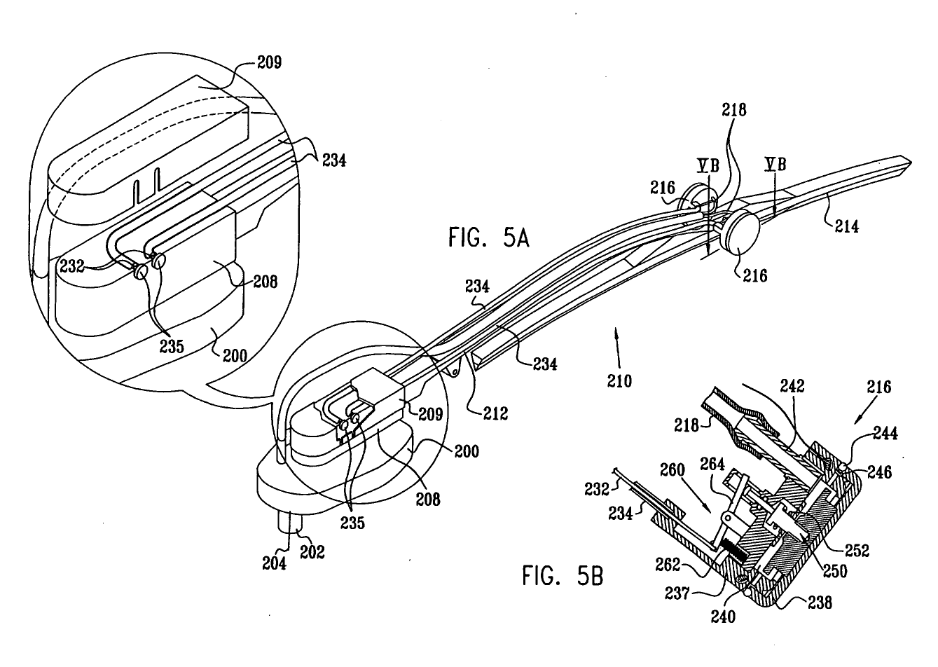

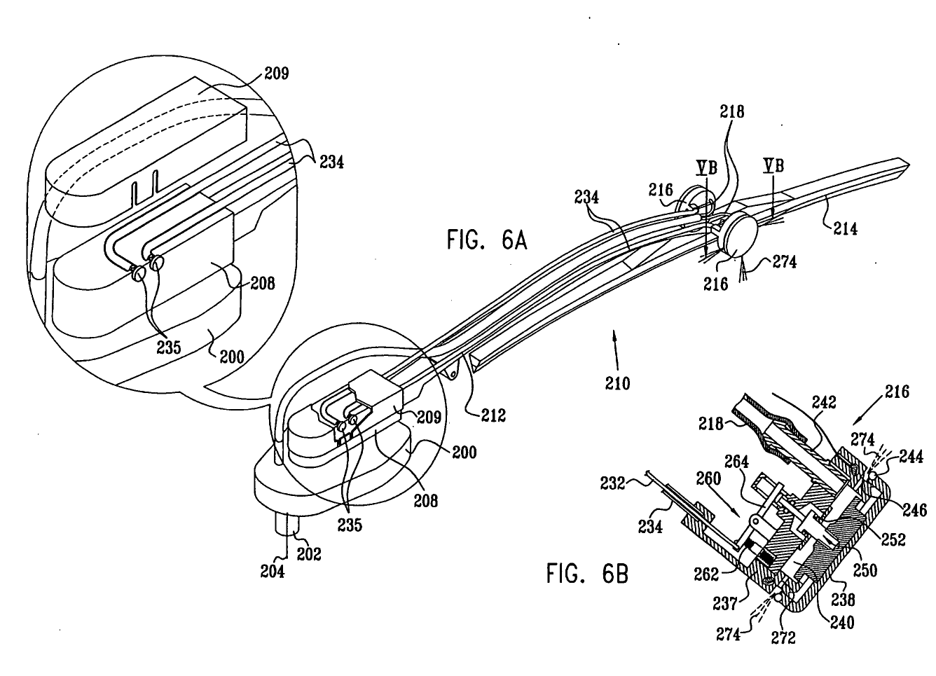

Reference is now made to FIGS. 5A and 5B and 6A and 6B, which are simplified illustrations of a windshield wiper and sprayer assembly constructed and operative in accordance with another preferred embodiment of the present invention, in respective closed and open operative orientation, FIGS. 5A and 6A being partially cut-away pictorial illustration and FIGS. 5B and 6B being sectional illustrations taken along lines 5B-5B and 6B-6B respectively.

As seen in FIGS. 5A-6B, the windshield wiper and sprayer assembly comprises a base 200 which is fixed to a shaft 202 which is arranged for rotation about a rotation axis 204. Shaft 202 is preferably driven for reciprocating rotational motion by a conventional wiper drive assembly (not shown), forming part of a conventional motor vehicle.

Cooperating with base 200 and arranged for rotation together therewith about rotation axis 204, is a housing 208 having a cover 209.

Fixed to base mounted housing 208 for rotational motion therewith is a windshield wiper and heated liquid sprayer assembly 210 including a support arm 212 mounted onto base mounted housing 208. Assembly 210 preferably includes a windshield wiper assembly 214 and a pair of heated liquid spray assemblies 216, all of which undergo rotational motion together with base mounted housing 208. Spray assemblies 216 receive pressurized fluid for spraying via fluid conduits 218.

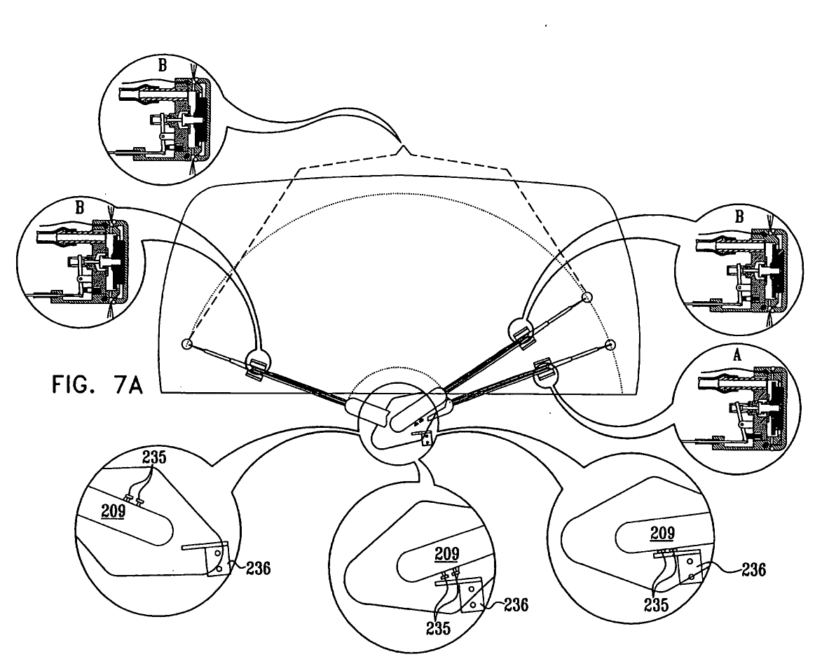

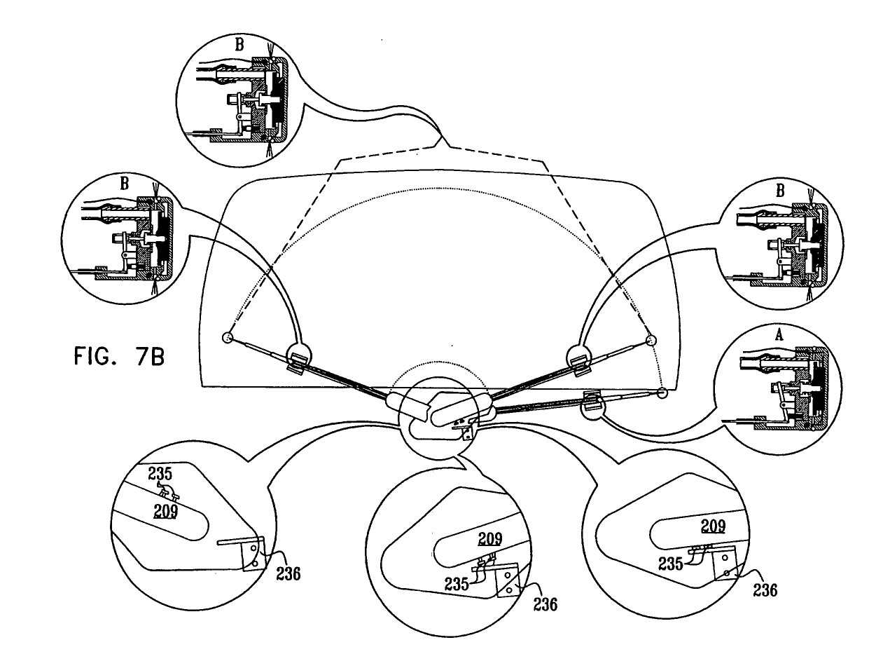

A pair of compression wires 232 extend through respective coaxial sleeves 234 from respective push buttons 235 mounted onto the base mounted housing 208 to spray assemblies 216. As will be explained hereinbelow, with particularly reference to FIGS. 7A and 7B, push buttons 235 are arranged to be depressed by engagement with an engagement member 236 when the windshield wiper assembly 214 reaches an extreme clockwise position, in the sense of FIGS. 7A and 7B, thereby sealing the spray assemblies 216.

Referring particularly to FIGS. 5B and 6B, it is seen that spray assemblies 216 each comprise a sprayer housing 237 and a cap portion 238 which is selectably closed by the action of compression wires 232.

In the preferred embodiment of the invention illustrated in FIGS. 5B and 6B, it is seen that a pressurized fluid chamber 240 is defined between the sprayer housing 237 and the cap 238 and receives pressurized fluid to be sprayed from the fluid conduits 218 via respective inlet pipes 242. The cap 238 may be sealed, preferably by means of an O-ring 244, and may be held tight against a corresponding sealing surface 246 of sprayer housing 237 by a spring loaded shaft assembly 250, which includes a compression spring 252.

As noted above, the spray assemblies 216 are normally open. This normally open state is the result of the action of a spring loaded lever assembly 260, attached to an end of each compression wire 232. Spring loaded lever assembly 260 preferably comprises a compression spring 262 which normally urges a lever arm 264 to engage the spring loaded shaft assembly 250, thereby overcoming the spring force of spring 252 and urging the cap 238 away from sprayer housing 237. In the illustrated embodiment, the spring force of compression spring 262 exceeds that of compression spring 252.

FIGS. 5A and 5B show base mounted housing 208 and windshield wiper and heated liquid sprayer assembly 210 at extreme inward radial orientations. In this orientation, the depression of push buttons 235 applies a compressive force to compression wires 232 sufficient to overcome the spring force of compression spring 262 and to force lever arm 264 to an orientation wherein it does not engage spring loaded shaft assembly 250 and does not overcome the spring force of spring 252. Spring 252 thus seals cap 238 against sprayer housing 237, as shown in FIG. 5B.

Termination of depression of push buttons 235, resulting from counterclockwise movement of the windshield wiper from its extreme clockwise orientation releases the compressive force earlier applied to wires 232 and thus enables compression spring 262 to extend and to force lever arm 264 to an orientation wherein it does not engage spring loaded shaft assembly 250 and does not overcome the spring force of spring 252 and urging the cap 238 away from sprayer housing 237, as shown in FIG. 6B, thereby allowing pressurized liquid to escape from pressurized fluid chamber 240 via conduits 272 and to produce a liquid spray 274.

In the illustrated embodiment, the orientation of lever arm 264 is such that the resulting closed to open travel of cap portion 238 relative to sprayer housing 237 is approximately 5 mm.

During further rotational movement of housing 208, compression wires 232 remain generally unstressed and compression spring 262 remains extended and continues to force lever arm 264 to an orientation wherein it continues to engage spring loaded shaft assembly 250 thereby overcoming the spring force of spring 252. Spring 252 continues to space cap 238 from sprayer housing 237, as shown in FIG. 6B, thereby allowing pressurized liquid to escape from pressurized fluid chamber 240 via conduits 272 and to produce a liquid spray 274.

It is a particular feature of the invention that even when the spray assembly 216 is in its closed position, sufficient liquid pressure applied to chamber 240 may overcome the spring force of spring 252 and permit spraying.

Reference is now made to FIG. 7A, which is a simplified illustration of the windshield wiper and sprayer assembly of FIGS. 5A-6B in various operative orientations in accordance with a preferred embodiment of the present invention. As seen in FIG. 7A, the orientation indicated by A correspond to the orientation shown in FIGS. 5A and 5B; the orientations indicated by B correspond to the orientation shown in FIGS. 6A and 6B.

Reference is now made to FIG. 7B, which is a simplified illustration of a variation of the windshield wiper and sprayer assembly of FIG. 7A in which the extreme clockwise orientation of the windshield wiper, wherein the spray assemblies are sealed lies below the windshield. As seen in FIG. 7B, the orientation indicated by A correspond to the orientation shown in FIGS. 5A and 5B; the orientations indicated by B correspond to the orientation shown in FIGS. 6A and 6B.

Reference is now made to FIG. 8, which is a simplified sectional illustration of a liquid heating assembly useful with the windshield wiper and sprayer assemblies of FIGS. 1-7B, constructed and operative in accordance with a preferred embodiment of the present invention. It is appreciated that the embodiment of FIG. 8 is not limited in its application to use with any given windshield wiper or sprayer assembly.

Turning to FIG. 8, it is seen that the liquid heating assembly comprises a chassis 300, preferably formed of a plastic material, which also serves as a multi-chamber housing and defines a liquid heating chamber 302 and a circuitry chamber 304. Liquid heating chamber 302 typically is sealed by a removably threaded base plate 306.

Disposed within liquid heating chamber 302, in sealing engagement with chassis 300, typically by means of a sealing ring 310, is a liquid heating volume defining subassembly 312. Subassembly 312 preferably includes a base portion 314 and a generally cylindrical wall portion 316 which is provided with a plurality of liquid inlet apertures 318 at various heights and azimuthal locations therealong. Base portion 314 and generally cylindrical wall portion 316 preferably define a liquid heating volume 320, in which there are preferably disposed first and second heating elements 322 and 324.

Liquid to be heated is typically received under pressure at an inlet 326 and passes through a conduit 328 into liquid heating chamber 302 and thence through apertures 318 into the liquid heating volume 320. Heated liquid typically exits at the top of the liquid heating chamber 320 via a conduit 330, also typically defined by chassis 300, and passes through a labyrinthine heating unit 332 to an outlet 334.

There exist a number of arrangements for providing pressurized liquid to be heated to inlet 326. In one such arrangement, an optional pump 335, which is not part of the original equipment in the vehicle, pressurizes liquid received via a conduit 336 from a liquid reservoir 337, which typically is part of the original equipment of the vehicle. Liquid from reservoir 337 may reach conduit 336 via a pump 338, which forms part of the original equipment of the vehicle, if that pump is a centrifugal pump. Alternatively, liquid from the reservoir 337 may pass through a one-way valve 339 directly to conduit 336.

It is appreciated that the provision of pump 335 together with the liquid heating assembly is particularly useful in retrofit situations, where modification of the operation and control of pump 338 would be inconvenient or impossible. Pump 335 may also be of value in non-retrofit installations in order to overcome the overall flow resistance of the system.

A liquid temperature sensor 340 preferably is located near the top of the liquid heating chamber 302 adjacent an inlet to conduit 330. Another temperature sensor 342 is preferably located in a wall 344 of the liquid heating chamber 302. Temperature sensor 342 preferably operates a circuit breaker switch 346, which is responsive to exceedance of a predetermined temperature threshold at sensor 342 for automatically interrupting the supply of electrical power from a vehicle battery 348 to the liquid heating assembly 300.

Temperature sensors 340 and 342 provide electrical outputs to electronic heating control circuitry 350, typically located in circuitry chamber 304. Electronic heating control circuitry 350 controls the electrical power, typically via circuit breaker switch 346, to first and second heating elements 322 and 324 and to labyrinthine heating unit 332 and preferably also controls the electrical power to pump 335 and/or to pump 338 which govern the supply of liquid under pressure at inlet 326. Electronic heating control circuitry 350 may also control the electrical power or provide an electrical control signal to windshield wipers (not shown) for producing reciprocating rotation thereof.

Preferably, there is provided an outside air temperature sensor 352 which provides an electric output to electronic heating control circuitry 350, enabling electronic heating control circuitry 350 to automatically control the operation of various components, including inter alia labyrinthine heating unit 332.

In accordance with a preferred embodiment of the present invention, a windshield dirt sensor 354 may be provided for automatically initiating operation of the liquid heating assembly when the windshield is dirty.

Additionally in accordance with a preferred embodiment of the present invention, the electronic heating control circuitry 350 includes functionality for inhibiting operation of the liquid heating assembly, when the electric power status of the vehicle does not meet predetermined criteria. For this purpose, a battery voltage sensor 356, a battery charging current sensor 358 and a vehicle engine rotation speed sensor 360 preferably provide outputs to electronic heating control circuitry 350.

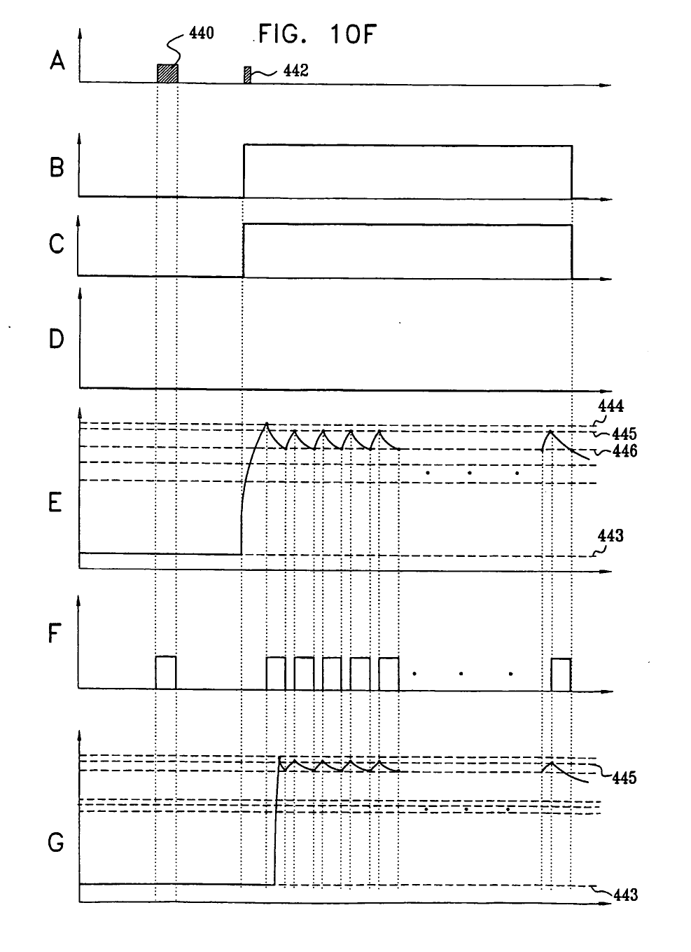

Further in accordance with a preferred embodiment of the present invention, a circulation pump 362 is preferably provided for circulating heated liquid from liquid heating volume 320 through conduits 364 and 366 to heat external components of the system such as liquid sprayers and windshield wiper blades, as described hereinbelow with reference to FIGS. 11-14, as well to heat heated liquid supply conduits, such as a conduit 368 coupled to outlet 334.

Circulation pump 362 may be operated by electronic heating control circuitry 350 automatically in response to ambient outside temperatures, sensed by sensor 352, which fall below a predetermined threshold or on the basis of any other suitable criteria.

Initiation of operation of the liquid heating assembly may be provided by means of a suitable operator controlled switch 370 which provides an output to electronic heating control circuitry 350. Alternatively, an operator controlled switch 372 may cause application of signal modulation to electrical power lines interconnecting battery 348 with electronic heating control circuitry 350. In such a case, electronic heating control circuitry 350 includes functionality for decoding such signal modulation and employing it for controlling functions of the liquid heating assembly, such as initiation of operation thereof.

In accordance with a preferred embodiment of the present invention, the liquid heating assembly of FIG. 8 may be operated in a standby mode, as described more fully hereinbelow with reference to FIG. 19. The standby mode may be actuated automatically as described hereinbelow and/or may be actuated by a vehicle operator using a standby mode actuation switch 373.

Reference is now made to FIGS. 9A and 9B, which are simplified illustrations of two alternative embodiments of a cylindrical wall portion of a liquid heating volume defining subassembly employed in the liquid heating assembly of FIG. 8.

FIG. 9A illustrates one preferred embodiment of the invention wherein liquid inlet apertures 374, 376 and 378 are located at various heights and azimuthal locations along a cylindrical wall portion 380. FIG. 9B illustrates an alternative embodiment wherein a generally vertical slot 382 may be provided in addition to one or more apertures 384 and 386 in a cylindrical wall portion 388.

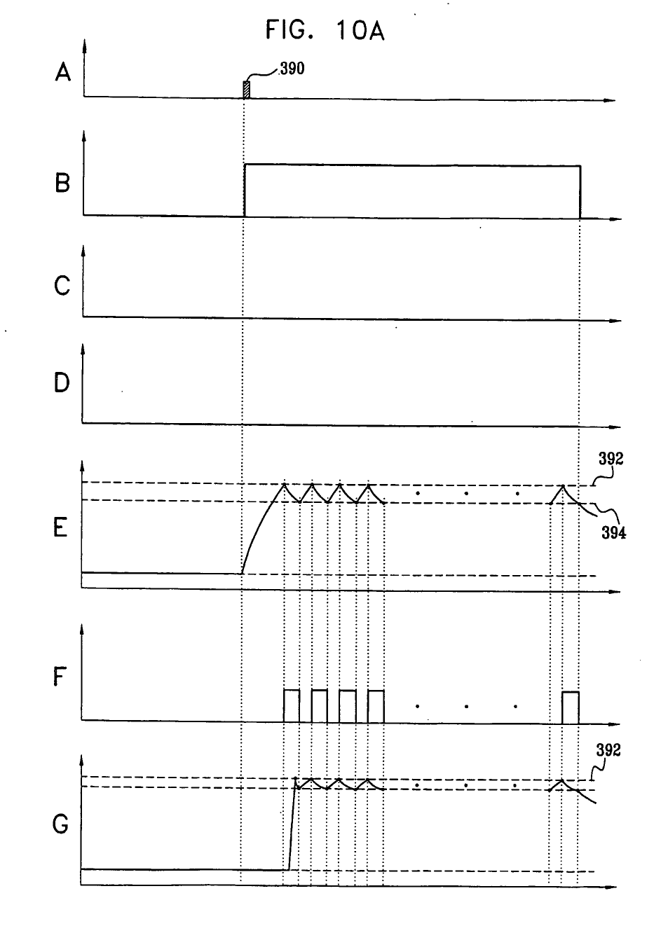

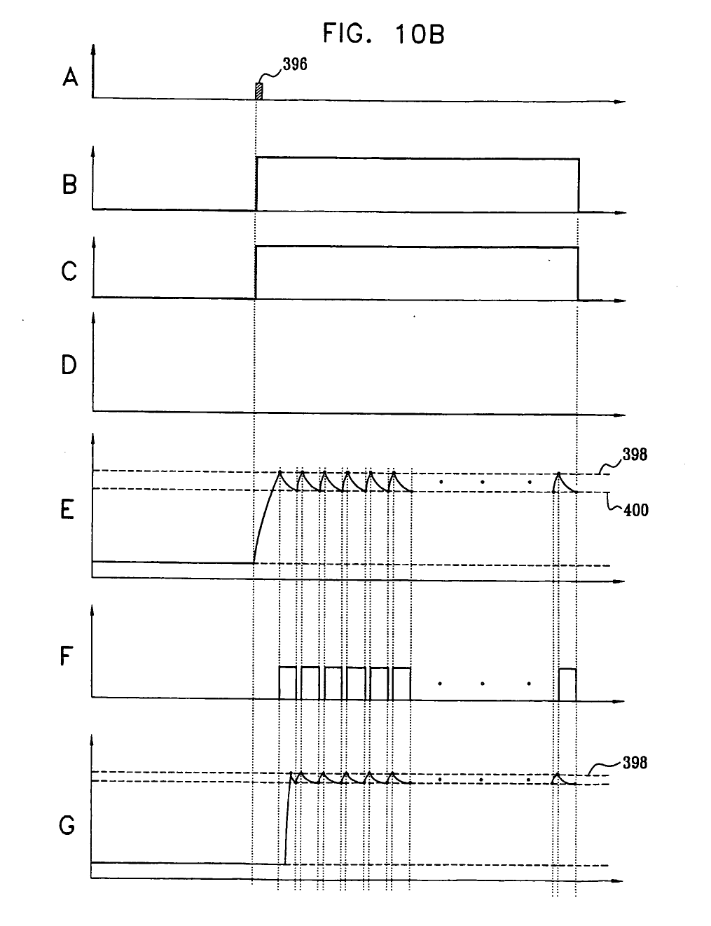

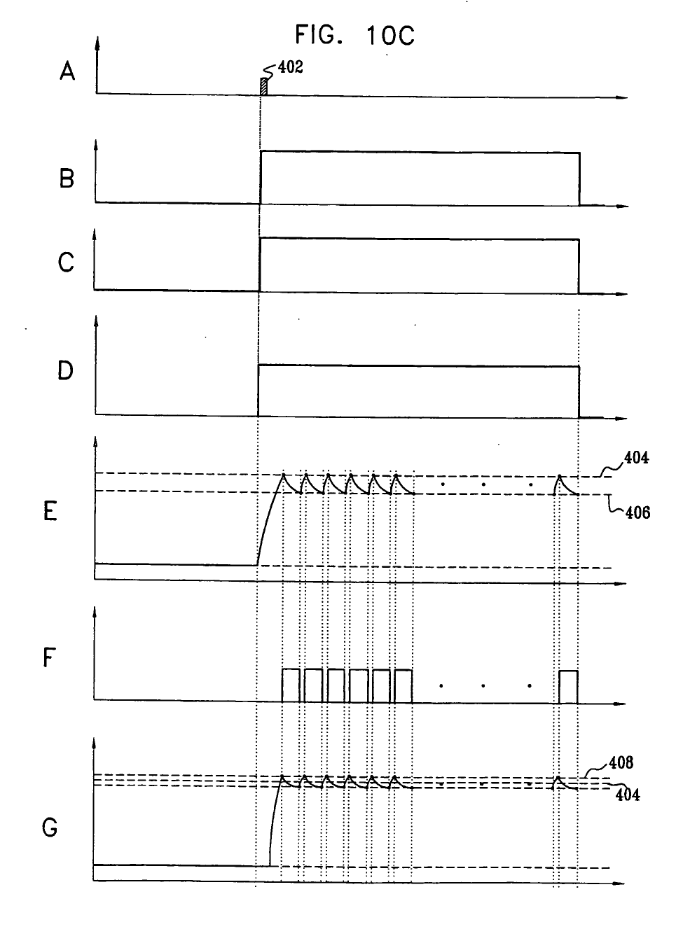

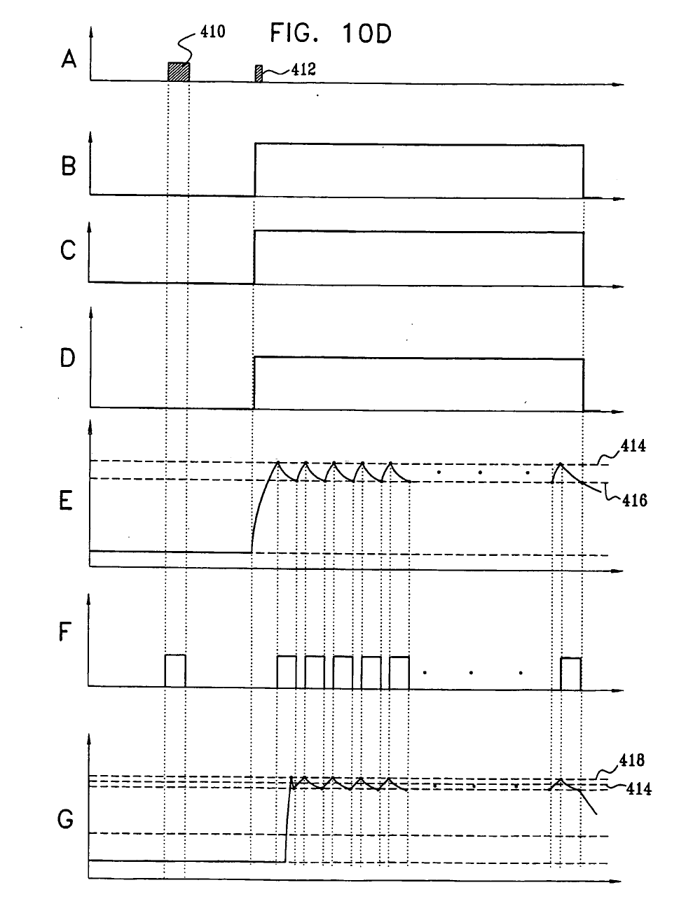

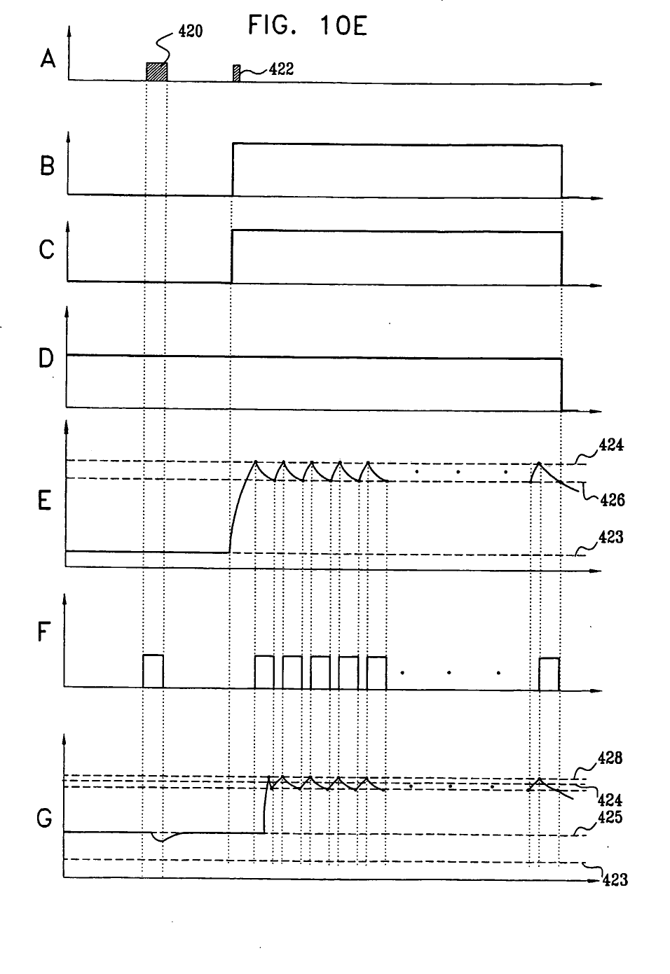

Reference is now made to FIGS. 10A, 10B, 10C, 10D, 10E and 10F, which are simplified timing diagrams illustrating various modes of operation of the liquid heating assembly of FIG. 8. Turning to FIG. 10A, it is seen that responsive to a heated liquid spray demand signal 390 (Trace A), typically provided by a vehicle operator pushing a push button, such as switch 370 or 372, associated with electronic heating control circuitry 350, heating element 322 is operated, as shown in Trace B. The duration of operation of heating element 322 is preferably approximately 3 minutes. In this mode of operation, heating element 324 and labyrinthine heating unit 332 are not operated, as indicated in Traces C and D respectively.

In accordance with a preferred embodiment of the present invention, the operation of heating element 322 is substantially continuous, as distinct from intermittent, thereby avoiding possible electrical interference resulting from high current switching.

Trace E shows the temperature at the outlet of the liquid heating chamber 302 as measured by sensor 340. It is seen that this temperature reaches a peak threshold value 392 and then periodically varies between the peak threshold value 392 and a somewhat lower threshold value 394. This variation in temperature corresponds to cycles of spraying heated liquid onto a vehicle windshield, which in turn corresponds to supply of unheated liquid to the liquid heating chamber 302, as shown in Trace F.

Preferably, pump 335 and/or pump 338 is actuated when the temperature measured by sensor 340 reaches the peak threshold value 392 and is deactuated when the temperature measured by sensor 340 falls to the lower threshold value 394. In this embodiment, where labyrinthine heating unit 332 is not operated, the temperature of the liquid at outlet 334 (Trace G) is generally the same as that measured by sensor 340. As seen in trace G, the amplitude of variation of the temperature at outlet 334 is typically less than that measured by sensor 340, due to the heat retaining capacity of the labyrinthine heating unit 332, even when not operated.

Turning to FIG. 10B, which shows an alternative mode of operation providing a higher frequency of liquid spraying, it is seen that responsive to a heated liquid spray demand signal 396 (Trace A), typically provided by a vehicle operator pushing one or more push buttons, such as switches 370 and 372, associated with electronic heating control circuitry 350, heating elements 322 and 324 are operated, as shown in Traces B and C, preferably for a duration of approximately 3 minutes. In this mode of operation, labyrinthine heating unit 332 is not operated, as indicated in Trace D.

In accordance with a preferred embodiment of the present invention, the operation of both of heating elements 322 and 324 is substantially continuous, as distinct from intermittent, thereby avoiding possible electrical interference resulting from high current switching.

Trace E shows the temperature at the outlet of the liquid heating chamber 302 as measured by sensor 340. It is seen that this temperature reaches a peak threshold value 398 and then periodically varies between the peak threshold value 398 and a somewhat lower threshold value 400. This variation in temperature corresponds to cycles of spraying heated liquid onto a vehicle windshield, which in turn correspond to supply of unheated liquid to the liquid heating chamber 302, as shown in Trace F.

Preferably, pump 335 and/or pump 338 is actuated when the temperature measured by sensor 340 reaches the peak threshold value 398 and is deactuated when the temperature measured by sensor 340 falls to the lower threshold value 400. In this embodiment, where labyrinthine heating unit 332 is not operated, the temperature of the liquid at outlet 334 (Trace G) is generally the same as that measured by sensor 340. As seen in trace G, the amplitude of variation of the temperature at outlet 334 is typically less than that measured by sensor 340, due to the heat retaining capacity of the labyrinthine heating unit 332, when not operated.

Comparing FIGS. 10B and 10A, it is seen that by operating two heating elements, namely heating elements 322 and 324 in the embodiment of FIG. 10B rather than only one heating element 322 as in the embodiment of FIG. 10A, the liquid in liquid heating chamber 302 is heated more quickly, and thus both the frequency of spraying and the amount of liquid sprayed during the typical 3 minute cycle duration increases. It is noted that in this embodiment, as compared with that of FIG. 10A, the heating time of the liquid as measured by sensor 340 is shortened, while the cooling time of the liquid during which operation of pump 335 and/or pump 338 takes place is somewhat lengthened.

Turning to FIG. 10C, which shows a further alternative mode of operation providing generally the same frequency of liquid spraying as in the embodiment of FIG. 10B, it is seen that responsive to a heated liquid spray demand signal 402 (Trace A), typically provided by a vehicle operator pushing one or more push buttons associated with electronic heating control circuitry 350, heating elements 322 and 324 and labyrinthine heating unit 332 are operated, as shown in Traces B, C and D. Actuation of the apparatus in the mode of operation shown in FIG. 10C may be in response to any suitable operator input or may be predetermined.

In accordance with a preferred embodiment of the present invention, the operation of both of heating elements 322 and 324 and of labyrinthine heating unit 332 is substantially continuous during each operating cycle, as distinct from intermittent, thereby avoiding possible electrical interference resulting from high current switching. The duration of operation of heating elements 322 and 324 and labyrinthine heating unit 332 is preferably about 3 minutes for each operating cycle.

Trace E shows the temperature at the outlet of the liquid heating chamber 302 as measured by sensor 340. It is seen that this temperature reaches a peak threshold value 404 and then periodically varies between the peak threshold value and a somewhat lower threshold value 406. This variation in temperature corresponds to cycles of spraying heated liquid onto a vehicle windshield, which in turn correspond to supply of unheated liquid to the liquid heating chamber 302, as shown in Trace F. Preferably, pump 335 and/or pump 338 is actuated when the temperature measured by sensor 340 reaches the peak threshold value 404 and is deactuated when the temperature measured by sensor 340 falls to the lower threshold value 406. In this embodiment, where labyrinthine heating unit 332 is operated, the temperature of the liquid at outlet 334 (Trace G), indicated by reference numeral 408, is generally higher than that measured by sensor 340. As seen in trace G, the amplitude of variation of the temperature at outlet 334 is typically less than that measured by sensor 340, due to the operation of the labyrinthine heating unit 332.

Comparing FIGS. 10C and 10B, it is seen that by operating the labyrinthine heating unit 332 in the embodiment of FIG. 10C in addition to the heating units 322 and 324 as in the embodiment of FIG. 10B, the liquid at outlet 334 is heated to a temperature peak 408 higher than that measured by sensor 340. This supplemental heating does not affect the frequency of spraying or the amount of liquid sprayed per unit time.

Turning to FIG. 10D, which shows a further alternative mode of operation providing generally the functionality of liquid spraying as in the embodiment of FIG. 10C, it is seen that an immediate spray demand signal, here designated by reference numeral 410, is provided in addition to the heated liquid spray demand signal (Trace A), typically by a vehicle operator pushing an additional push button associated with electronic heating control circuitry 350 or executing any other suitable driver initiated actuation.

In response to the immediate spray demand signal 410, pump 335 and/or pump 338 is operated to provide a supply of pressurized liquid from liquid heating chamber 302 to outlet 334 even before commencement of operation of heating elements 322 and 324.

At any time relative to immediate spray demand signal 410, a heated liquid spray demand signal, here designated by reference numeral 412 (Trace A) may also be provided by an operator pushing one or more push buttons associated with electronic heating control circuitry 350, causing heating elements 322 and 324 and labyrinthine heating unit 332 to be operated, as shown in Traces B, C and D.

As in the embodiment of FIG. 10C, the operation of both of heating elements 322 and 324 and labyrinthine heating unit 332 is substantially continuous, as distinct from intermittent, thereby avoiding possible electrical interference resulting from high current switching. Typically the duration of operation of heating elements 322 and 324 and of labyrinthine heating unit 332 is approximately 3 minutes per operating cycle.

Trace E shows the temperature at the outlet of the liquid heating chamber 302 as measured by sensor 340. It is seen that when the heating elements 322 and 324 are operated, this temperature reaches peak threshold value 414 and then periodically varies between the peak threshold value and a somewhat lower threshold value 416. This variation in temperature corresponds to cycles of spraying heated liquid onto a vehicle windshield, which in turn correspond to supply of unheated liquid to the liquid heating chamber 302, as shown in Trace F.

Preferably, following provision of the heated liquid spray demand signal 412, pump 335 and/or pump 338 is actuated when the temperature measured by sensor 340 reaches the peak threshold value 414 and is deactuated when the temperature measured by sensor 340 falls to the lower threshold value 416. Pump 335 and/or pump 338 is also actuated in response to signal 410, as noted above.

In this embodiment, during operation of labyrinthine heating unit 332, the temperature 418 of the liquid at outlet 334 (Trace G) is higher than that measured by sensor 340. As seen in trace G, the amplitude of variation of the temperature at outlet 334 is typically less than that measured by sensor 340, due to the operation of the labyrinthine heating unit 332.

Comparing FIGS. 10D and 10C, it is seen that operation of pump 335 and/or pump 338 in response to immediate spray demand signal 410, does not interfere with the operation of the apparatus as described hereinabove with reference to FIGS. 10A-10C.

Comparing FIGS. 10D and 10B, it is seen that by operating the labyrinthine heating unit 332 in the embodiment of FIG. 10D in addition to the heating units 322 and 324 as in the embodiment of FIG. 10B, the liquid at outlet 334 is heated to a temperature peak 418 higher than that measured by sensor 340. This supplemental heating does not affect the frequency of spraying or the amount of liquid sprayed per unit time.

Turning to FIG. 10E, which shows a further alternative mode of operation providing generally the functionality of liquid spraying as in the embodiment of FIG. 10D, it is seen that an immediate spray demand signal, here designated by reference numeral 420, is provided in addition to the heated liquid spray demand signal 422 (Trace A), typically by a vehicle operator pushing an additional push button, such as push buttons 370 and 372, associated with electronic heating control circuitry 350 or executing any other suitable driver initiated actuation.

Prior to heated liquid spray demand signal 422, and preferably upon ignition of a vehicle when the ambient outside temperature measured by sensor 352 is below a certain predetermined threshold, the labyrinthine heating unit 332 may be actuated, as shown in Trace D.

In response to the immediate spray demand signal 420, pump 335 and/or pump 338 is operated to provide a supply of pressurized liquid from liquid heating chamber 302 to outlet 334 even before operation of heating elements 322 and 324, as shown by Trace F.

Trace E shows the temperature at the outlet of the liquid heating chamber 302 as measured by sensor 340. It is seen that when the heating elements 322 and 324 are operated, this temperature is raised from an ambient temperature 423 and reaches a peak threshold value 424 and then periodically varies between the peak threshold value and a somewhat lower threshold value 426. This variation in temperature corresponds to cycles of spraying heated liquid onto a vehicle windshield, which in turn correspond to supply of unheated liquid to the liquid heating chamber 302, as shown in Trace F.

Preferably, following provision of the heated liquid spray demand signal 422, pump 335 and/or pump 338 is actuated when the temperature measured by sensor 340 reaches the peak threshold value 424 and is deactuated when the temperature measured by sensor 340 falls to the lower threshold value 426. Pump 335 and/or pump 338 is also actuated in response to signal 420, as noted above.

In this embodiment, during operation of labyrinthine heating unit 332, the temperature of the liquid at outlet 334 (Trace G) is higher than that measured by sensor 340. Due to operation of labyrinthine heating unit 332 from the outset, the base temperature of the liquid at outlet 334 is an elevated temperature indicated by reference numeral 425, higher than ambient temperature 423, prior to immediate spray demand signal 420. During operation of pump 335 and/or pump 338, in response to immediate spray demand signal 420, the temperature of the liquid at outlet 334 drops slightly as unheated liquid is supplied to labyrinthine heating unit 332.

As in the embodiments of FIGS. 10C and 10D, the operation of both of heating elements 322 and 324 and labyrinthine heating unit 332 is substantially continuous, as distinct from intermittent, thereby avoiding possible electrical interference resulting from high current switching. Preferably the duration of continuous operation of heating elements 322 and 324 is approximately 3 minutes for each operating cycle.

During the operational cycle responsive to heated liquid spray demand signal 422, the temperature of the liquid at outlet 334 reaches a temperature 428 and the amplitude of variation of the temperature at outlet 334 is typically less than that measured by sensor 340, due to the operation of the labyrinthine heating unit 332.

Comparing FIGS. 10E and 10C, it is seen that operation of pump 335 and/or pump 338 in response to immediate spray demand signal 410, does not interfere with the operation of the apparatus as described hereinabove with reference to FIGS. 10A-10C.

Comparing FIGS. 10E and 10B, it is seen that by operating the labyrinthine heating unit 332 in the embodiment of FIG. 10E in addition to the heating units 322 and 324 as in the embodiment of FIG. 10B, the liquid at outlet 334 is heated to a temperature peak 428 higher than that measured by sensor 340. This supplemental heating does not affect the frequency of spraying or the amount of liquid sprayed per unit time.

Fig. 10F shows a further alternative mode of operation of the apparatus of FIG. 8, wherein the temperature thresholds applied to the temperature sensed by sensor 340 are varied in accordance with the boiling point of the spray liquid. This mode provides efficient heating of the spray liquid without unnecessarily heating the liquid beyond its boiling point.

It is appreciated that the boiling point of the spray liquid is a function of the concentration of antifreeze and other additives therein. In this embodiment, electronic heating control circuitry 350 is operative to monitor the temperature sensed by sensor 340. Once a relatively stable temperature 444 is reached during continuous operation of one or both of heating elements 322 and 324, indicating that the boiling temperature has been reached, that stable temperature 444 is noted by circuitry 350, which sets a peak temperature threshold value 445 to be preferably a few degrees Celsius below the sensed stable temperature, which is designated by reference numeral 444. In this manner energy and liquid heating of the spray liquid is realized.

It is appreciated that in the illustrated mode of operation, the labyrinthine heating unit 332 is not operated, as shown in Trace D. However, it is envisgaged that in this mode of operation the labyrinthine heating unit 332 may be operated.

Turning to FIG. 10F, it is seen that an immediate spray demand signal, here designated by reference numeral 440, may be provided in addition to a heated liquid spray demand signal 442 (Trace A), typically by a vehicle operator pushing an additional push button, such as push buttons 370 and 372, associated with electronic heating control circuitry 350 or executing any other suitable driver initiated actuation.

In response to the immediate spray demand signal 440, pump 335 and/or pump 338 is operated to provide a supply of pressurized liquid from liquid heating chamber 302 to outlet 334 even before operation of heating elements 322 and 324.

Trace E shows the temperature at the outlet of the liquid heating chamber 302 as measured by sensor 340. It is seen that when the heating elements 322 and 324 are operated, this temperature begins from an ambient temperature 443 and initially reaches stable temperature 444 and thereafter is limited to a peak threshold value 445 and then periodically varies between the peak threshold value 445 and a somewhat lower threshold value 446. This variation in temperature corresponds to cycles of spraying heated liquid onto a vehicle windshield, which in turn correspond to supply of unheated liquid to the liquid heating chamber 302, as shown in Trace F.

Preferably, following provision of the heated liquid spray demand signal 442, pump 335 and/or pump 338 is actuated when the temperature measured by sensor 340 reaches the peak threshold value 445 and is deactuated when the temperature measured by sensor 340 falls to the lower threshold value 446. Pump 335 and/or pump 338 is also actuated in response to signal 440, as noted above.

Preferably, pump 335 and/or pump 338 is actuated when the temperature measured by sensor 340 reaches the peak threshold value 445 and is deactuated when the temperature measured by sensor 340 falls to the lower threshold value 446. In this embodiment, where labyrinthine heating unit 332 is not operated, the temperature of the liquid at outlet 334 (Trace G) is generally the same as that measured by sensor 340. As seen in trace G, the amplitude of variation of the temperature at outlet 334 is typically less than that measured by sensor 340, due to the heat retaining capacity of the labyrinthine heating unit 332, when not operated.

As in the mode of operation of FIG. 10B, the operation of both of heating elements 322 and 324 is substantially continuous, as distinct from intermittent, thereby avoiding possible electrical interference resulting from high current switching. The duration of operation of heating elements 322 and 324 is preferably approximately 3 minutes for each operating cycle thereof.

Comparing FIGS. 10F and 10E, it is seen that operation of the apparatus of FIG. 8 in a variable peak temperature threshold mode in response to the sensed boiling point of the spray liquid which may vary over time does not interfere with the operation of the apparatus as described hereinabove with reference to FIGS. 10A-10E.

Comparing FIGS. 10F and 10C, it is seen that operation of pump 335 and/or pump 338 in response to immediate spray demand signal 440, does not interfere with the operation of the apparatus as described hereinabove with reference to FIGS. 10A-10C.

It is appreciated that operation of the apparatus of FIG. 8 in a variable peak temperature threshold mode causes the peak temperature 445 to be a function of the composition of the liquid. Peak temperature 445 may thus be greater or less than peak temperature 398 in FIG. 10B.

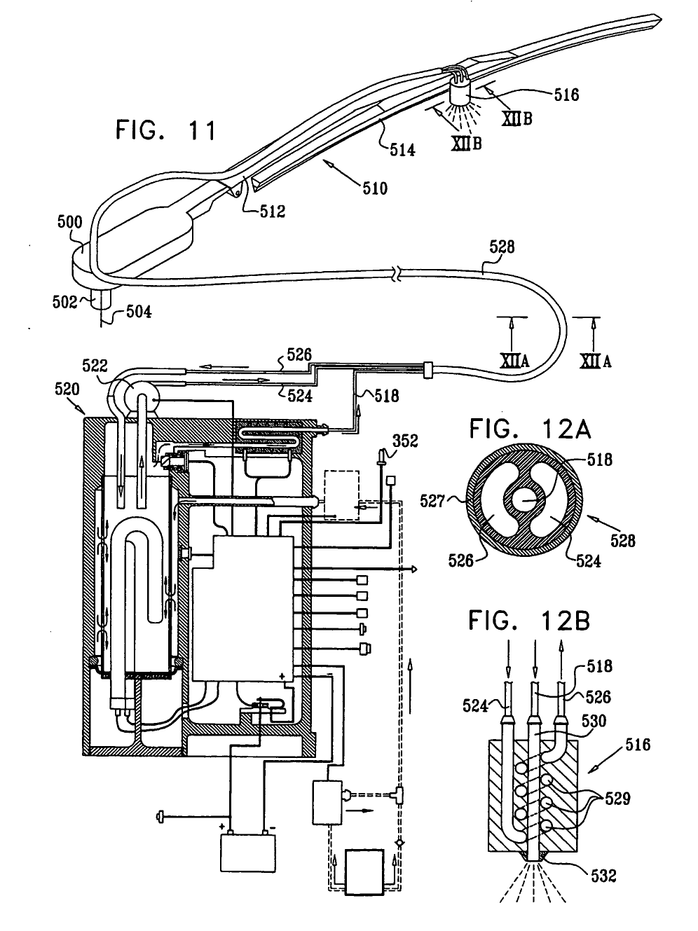

Reference is now made to FIG. 11, which is a simplified partially pictorial illustration of a windshield wiper and sprayer assembly constructed and operative in accordance with another preferred embodiment of the present invention and FIGS. 12A and 12B, which are sectional illustrations taken along respective lines XIIA-XIIA and XIIB-XIIB in FIG. 11.

As seen in FIGS. 11, 12A and 12B, the windshield wiper and sprayer assembly comprises a base 500 which is fixed to a shaft 502 which is arranged for rotation about a rotation axis 504. Shaft 502 is preferably driven for reciprocating rotational motion by a conventional wiper drive assembly (not shown), forming part of a conventional motor vehicle.

Attached to base 500 for reciprocating rotational motion therewith is a windshield wiper and heated liquid sprayer assembly 510 including a support arm 512 mounted onto base 500. Assembly 510 preferably includes a windshield wiper assembly 514 and at least one heated liquid spray assembly 516, which undergoes reciprocating rotational motion together with base 500. Spray assembly 516 receives pressurized fluid for spraying via a fluid conduit 518 from a liquid heating assembly 520, which may be identical to the liquid heating assembly shown in FIG. 8.

Optionally, as in the embodiment of FIGS. 1A-7B, base 500 may have associated therewith a housing (not shown) arranged for driven linear motion relative thereto. This linear motion is preferably provided by a cam drive assembly (not shown). Suitable drive assemblies of this type are commercially available on windshield wiper assemblies installed as original equipment on Mercedes-Benz automobiles, such as Model No. 220C.

In the illustrated embodiment, heated liquid from liquid heating assembly 520 is circulated alongside fluid conduit 518 and through heated liquid spray assembly 516, preferably by a pump 522 cooperating with a pair of conduits 524 and 526, which are joined at the liquid spray assembly 516 to define a continuous circulation path.

It is a particular feature of the present invention that conduits 524 and 526 may be defined in a unitary conduit element 528, a preferred cross-section of which is shown in FIG. 12A, wherein conduits 524 and 526 preferably generally surround conduit 518 for efficient heat transfer therewith. External thermal insulation 527 is preferably provided.

As seen in FIG. 12B, liquid spray assembly 516 is preferably formed with an internal liquid circulation path 529 to which conduits 524 and 526 are coupled. Liquid circulation path 529 surrounds a heated spray liquid pathway 530 which couples conduit 518 to a spray head 532.

In practice, upon initiation of a heated spray operation by a vehicle operator, pump 522 preferably is immediately actuated to begin circulating liquid from the liquid heater assembly 520, thus monotonically heating both the liquid spray assembly 516 and the liquid in conduit 518, such that the liquid in conduit 518, when sprayed, is heated to a temperature above the ambient. This is particularly useful when relatively long conduits 518 are present, such as in systems providing heated liquid sprays for rear windows and headlights.

Reference is now made to FIG. 13, which is a simplified partially pictorial illustration of a windshield wiper and sprayer assembly constructed and operative in accordance with yet another preferred embodiment of the present invention.

As seen in FIG. 13, the windshield wiper and sprayer assembly comprises a base 550 which is fixed to a shaft 552, arranged for rotation about a rotation axis 554. Shaft 552 is preferably driven for reciprocating rotational motion by a conventional wiper drive assembly (not shown), forming part of a conventional motor vehicle. Attached to base 550 for rotational motion therewith is a windshield wiper and heated liquid sprayer assembly 560 including a support arm 562, mounted onto base 550. Assembly 560 preferably includes a windshield wiper assembly 564 and at least one heated liquid spray assembly 566, which undergoes rotational motion together with base 550. Spray assembly 566 receives pressurized fluid for spraying via a fluid conduit 568 from a liquid heating assembly 570, which may be identical to the liquid heating assembly shown in FIG. 8.

Optionally, as in the embodiment of FIGS. 1A-7B, base 550 may have associated therewith a housing (not shown) arranged for driven linear motion relative thereto. This linear motion is preferably provided by a cam drive assembly (not shown). Suitable drive assemblies of this type are commercially available on windshield wiper assemblies installed as original equipment on Mercedes-Benz automobiles, such as Model No. 220C.

In the illustrated embodiment, heated liquid from liquid heating assembly 570 is circulated alongside fluid conduit 568 and through heated liquid spray assembly 566, preferably by a pump 572 cooperating with a pair of conduits 574 and 576, which are joined at the liquid spray assembly 566 to define a continuous circulation path.

It is a particular feature of the present invention that conduits 574 and 576 may be defined in a unitary conduit element 578, wherein conduits 574 and 576 preferably generally surround conduit 568 for efficient heat transfer therewith and including external thermal insulation (not shown).

In this embodiment, liquid spray assembly 566 preferably comprises a sealed volume 580 which receives spray liquid under pressure from conduit 568 at an inlet 582 and is provided with a plurality of spray outlets 584 for spraying the liquid under pressure onto a vehicle windshield. An internal heat exchanging liquid circulation pathway element 586 is preferably disposed within sealed volume 580. Conduits 574 and 576 are coupled to element 586.

In practice, upon initiation of a heated spray operation by a vehicle operator, pump 572 preferably is immediately actuated to begin circulating liquid from the liquid heater assembly 570, thus monotonically heating both the liquid spray assembly 566 and the liquid in conduit 568, such that the liquid in conduit 568, when sprayed, is heated to a temperature above the ambient. This is particularly useful when relatively long conduits 568 are present, such as in systems providing heated liquid sprays for rear windows and headlights.

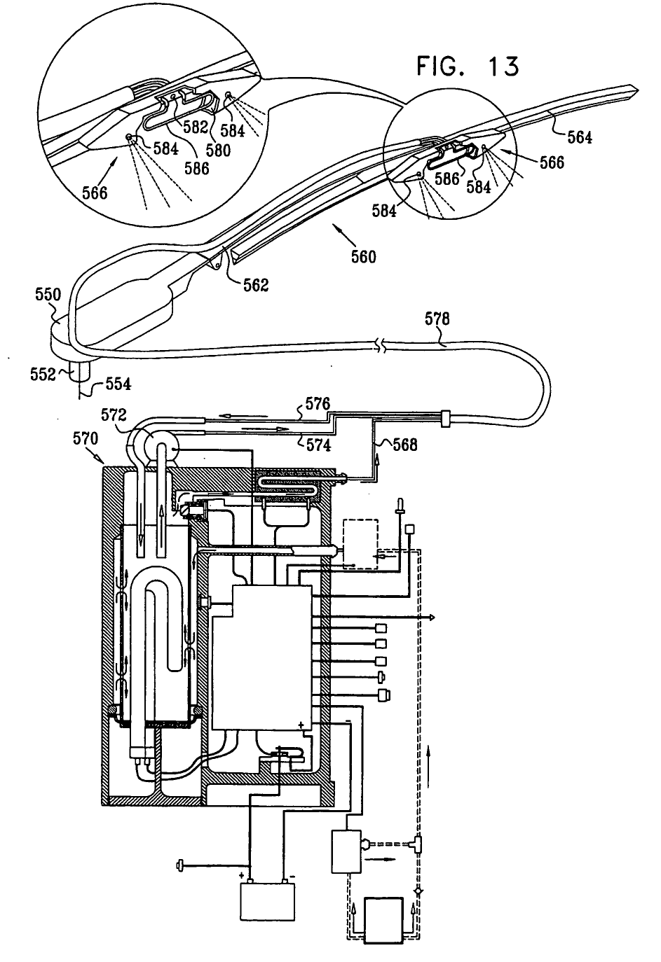

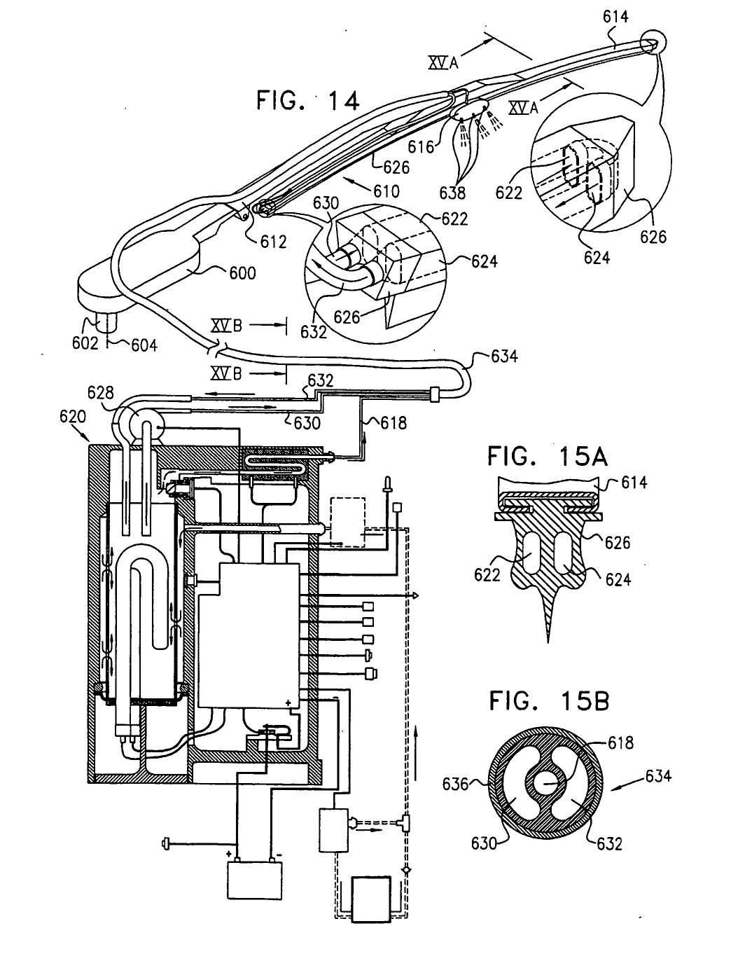

Reference is now made to FIG. 14, which is a simplified partially pictorial illustration of a windshield wiper and sprayer assembly constructed and operative in accordance with another preferred embodiment of the present invention and FIGS. 15A and 15B, which are sectional illustrations taken along respective lines XVA-XVA and XVB-XVB in FIG. 14.

As seen in FIGS. 14, 15A and 15B, the windshield wiper and sprayer assembly comprises a base 600 which is fixed to a shaft 602 which is arranged for rotation about a rotation axis 604. Shaft 602 is preferably driven for reciprocating rotational motion by a conventional wiper drive assembly (not shown), forming part of a conventional motor vehicle.

Attached to base 600 for reciprocating rotational motion therewith is a windshield wiper and heated liquid sprayer assembly 610 including a support arm 612 mounted onto base 600. Assembly 610 preferably includes a windshield wiper assembly 614 and at least one heated liquid spray assembly 616, which undergoes reciprocating rotational motion together with base 600. Spray assembly 616 receives pressurized fluid for spraying via a fluid conduit 618 from a liquid heating assembly 620, which may be identical to the liquid heating assembly shown in FIG. 8.

Optionally, as in the embodiment of FIGS. 1A-7B, base 600 may have associated therewith a housing (not shown) arranged for driven linear motion relative thereto. This linear motion is preferably provided by a cam drive assembly (not shown). Suitable drive assemblies of this type are commercially available on windshield wiper assemblies installed as original equipment on Mercedes-Benz automobiles, such as Model No. 220C.

In the illustrated embodiment, heated liquid from liquid heating assembly 620 is circulated alongside fluid conduit 618 and through a pair of joined conduits 622 and 624 in a windshield wiper blade 626, shown in FIG. 15A, preferably by a pump 628 cooperating with a pair of conduits 630 and 632, which are coupled to conduits 622 and 624 to define a continuous circulation path.

It is a particular feature of the present invention that conduits 630 and 632 may be defined in a unitary conduit element 634, a preferred cross-section of which is shown in FIG. 15B, wherein conduits 630 and 632 preferably generally surround conduit 618 for efficient heat transfer therewith. External thermal insulation 636 is preferably provided.

Liquid spray assembly 616 is preferably formed with a sealed volume which receives spray liquid under pressure from conduit 618 and is provided with a plurality of spray outlets 638 for spraying the liquid under pressure onto a vehicle windshield.

In practice, upon initiation of a heated spray operation by a vehicle operator, pump 628 preferably is immediately actuated to begin circulating liquid from the liquid heater assembly 620, thus monotonically heating both the wiper blade 626 and the liquid in conduit 618, such that the liquid in conduit 618, which sprayed, is heated to a temperature above the ambient. This is particularly useful when relatively long conduits 618 are present, such as in systems providing heated liquid sprays for rear windows and headlights.

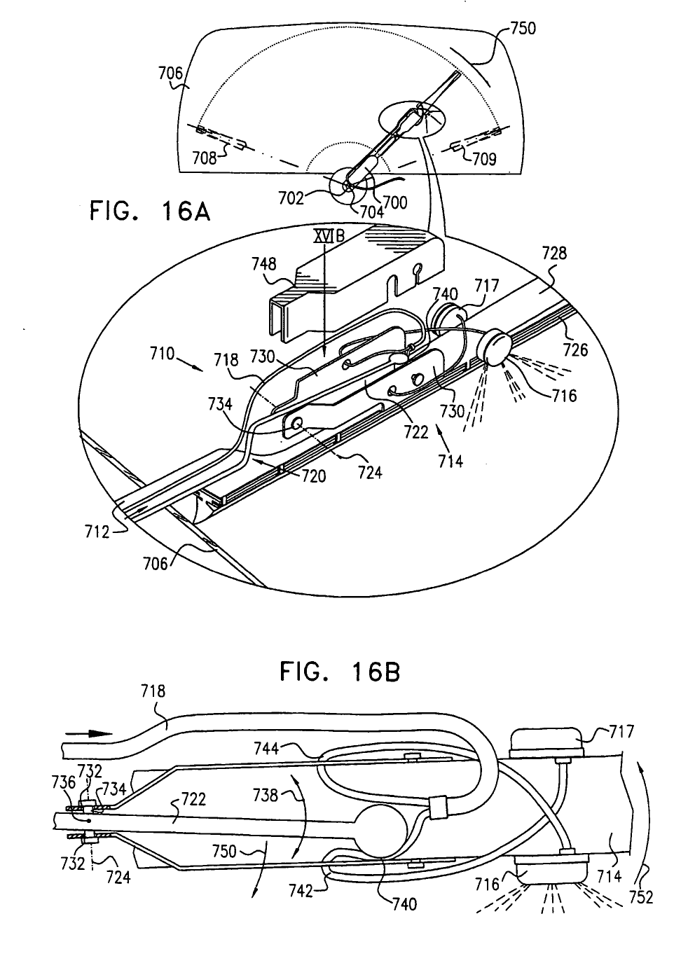

Reference is now made to FIGS. 16A and 16B, 17A and 17B and 18A and 18B, which are illustrations of a windshield wiper and sprayer assembly having a wiping direction responsive spray functionality constructed and operative in accordance with a preferred embodiment of the present invention. FIGS. 16B, 17B and 18B are taken in the direction of lines XVIB, XVIIB and XVIIB, respectively. Turning to FIGS. 16A and 16B, there is seen a windshield wiper and sprayer assembly comprising a base 700 which is fixed to a shaft 702 which is arranged for rotation about a rotation axis 704 along a windshield 706 between extreme positions 708 and 709. Shaft 702 is preferably driven for reciprocating rotational motion by a conventional wiper drive assembly (not shown), forming part of a conventional motor vehicle.

Attached to base 700 for rotational motion therewith is a windshield wiper and heated liquid sprayer assembly 710 including a support arm 712 mounted onto base 700. Assembly 710 preferably includes a windshield wiper assembly 714 and a pair of liquid sprayers 716 and 717, which undergo rotational motion together with base 700. Spray assembly 716 receives pressurized liquid for spraying via a fluid conduit 718 from any suitable source of liquid and preferably from a liquid heating assembly (not shown), which may be identical to the liquid heating assembly shown in FIG. 8.

As seen in FIGS. 16A and 16B, the support arm 712 is preferably twisted adjacent a distal end thereof, as indicated by reference numeral 720 so as to present an end portion 722, which lies in a plane generally perpendicular to the surface of windshield 706. Loosely pivotably mounted onto end portion 722, generally along an axis 724 is windshield wiper assembly 714, preferably including a conventional wiper blade 726 which may be slidably and removably mounted within a track support element 728.

Track support element 728 is preferably integrally formed with a pair of side attachment walls 730 which are formed with aligned apertures 732 through which extends an axle 734 which extends generally along axis 724. This arrangement allows the windshield wiper assembly 714 to be pivoted about axis 724 in a conventional manner.

It is a particular feature of the present invention that the loose mounting of windshield wiper assembly 714 onto end portion 722 also allows pivoting of track support element 728 relative to the end portion 722 about a pivot axis 736, which preferably intersects axis 724. The extent of this pivoting is generally represented by arrows 738. The pivoting about axis 736, represented by arrows 738, is employed in accordance with a preferred embodiment of the invention, to direct liquid to one or both of sprayers 716 and 717 in accordance with the direction of movement of the windshield wiper assembly 714 at any given instant.

In the illustrated embodiment of the invention, formed onto end portion 722 is at least one engagement surface 740 which can be brought into liquid flow interrupting operative engagement with one of two liquid conduits 742 and 744, which receive pressurized liquid via conduit 718, thereby interrupting liquid flow therethrough.

Preferably the end portion 722 and side attachment walls 730 are protected from the elements by a cover 748.

As seen in FIGS. 16A and 16B, when the windshield wiper assembly 714 moves in a first direction relative to support arm 712, indicated by reference numeral 750, the resulting friction causes the windshield wiper assembly to pivot about axis 736 in a direction designated by reference numeral 752, causing engagement surface 740 to engage liquid conduit 742, thus generally preventing liquid flow therethrough and thus directing all of the pressurized liquid through conduit 744 to sprayer 716.

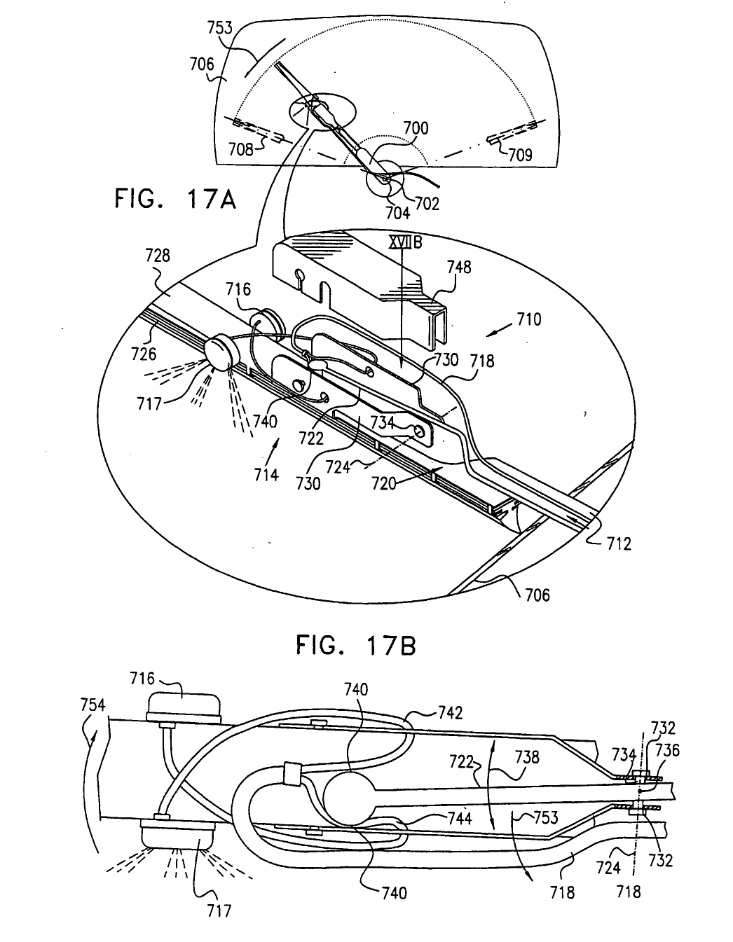

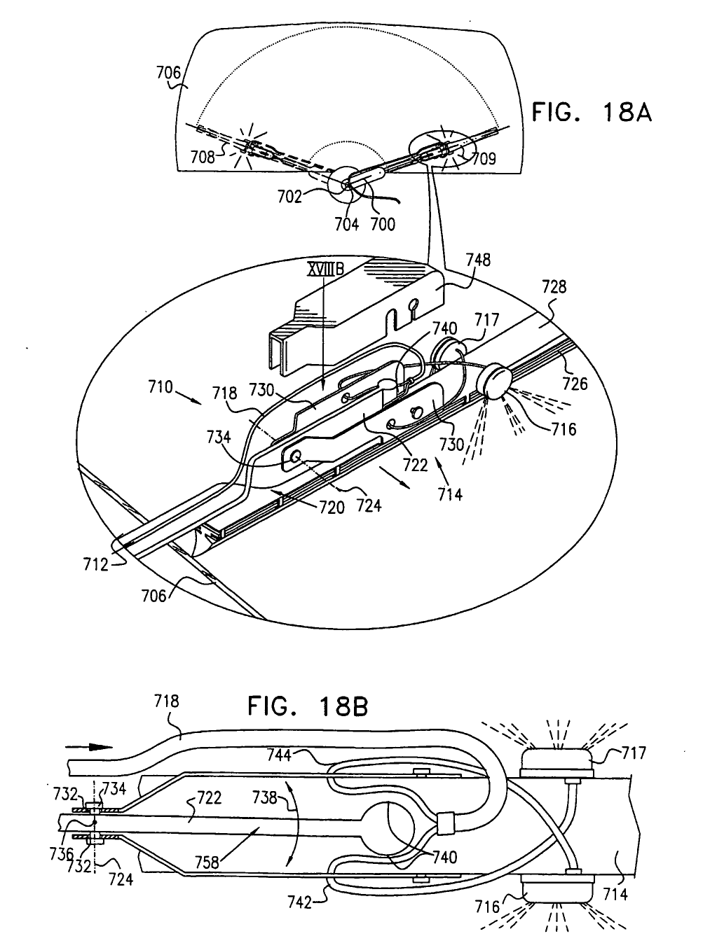

As seen in FIGS. 17A and 17B, when the windshield wiper assembly 714 moves in a second direction relative to support arm 712, indicated by reference numeral 753, the resulting friction causes the windshield wiper assembly to pivot about axis 736 in an opposite direction, designated by reference numeral 754, causing engagement surface 740 to engage liquid conduit 744, thus generally preventing liquid flow therethrough and thus directing all of the pressurized liquid through conduit 742 to sprayer 717.

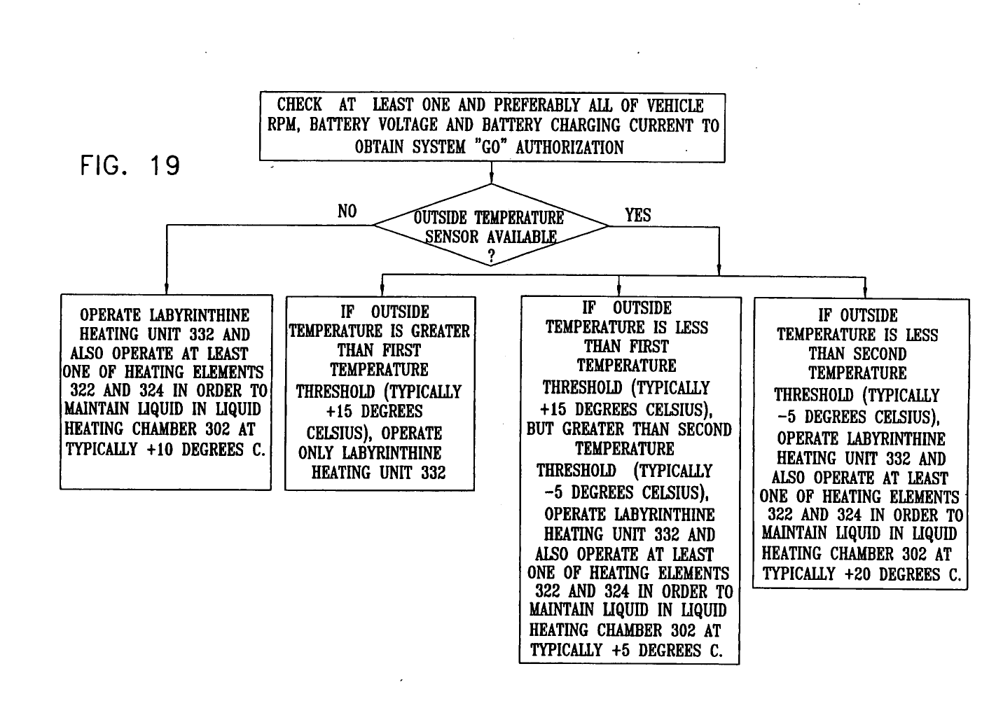

As seen in FIGS. 18A and 18B when the windshield wiper assembly is at an extreme location, such as either of locations 708 and 709, the windshield wiper assembly 714 lies at an intermediate location designated by reference numeral 758, causing engagement surface 740 to prevent liquid flow through neither of conduits 742 and 744.

Reference is now made to FIG. 19, which is a simplified flow chart illustration of standby operation of the liquid heating assembly of FIG. 8. As seen in FIG. 19, the electronic heating control circuitry 350 preferably operates in a standby mode in response to the status of the vehicle, as indicated by sensors 356, 358 and 360 and in response to the outside temperature, as indicated by sensor 352. Alternatively or additionally, standby mode operation of electronic heating control circuitry 350 may be provided by actuation of switch 373 by a vehicle operator.

Preferably, upon vehicle ignition, electronic heating control circuitry 350 checks at least one and preferably all of the following vehicle characteristics: vehicle battery voltage, as measured by sensor 356; vehicle battery charging current, as measured by sensor 358 and vehicle engine rotation speed, as measured by sensor 360. Preferable minimum vehicle characteristic thresholds are as follows:
vehicle battery voltage: 12.5 Volts;
vehicle battery charging current: 15 Ampere
vehicle engine rotation speed: 1000 RPM

If the minimum vehicle characteristic thresholds are met, a “GO” authorization is provided and the liquid heating assembly is operated in a standby mode as follows:

If an outside temperature sensor, such as sensor 352 is not available, preferably electronic heating control circuitry 350 operates labyrinthine heating unit 332 and also operates at least one of heating elements 322 and 324 in order to maintain the liquid in liquid heating chamber 302 at typically +10 degrees C.

If an outside temperature sensor, such as sensor 352, is available, and the outside temperature measured thereby is greater than a first temperature threshold, typically +15 degrees C., preferably only labyrinthine heating unit 332 is operated.

If, the outside temperature measured by the outside temperature sensor 352 is less than the first temperature threshold, but greater than a second temperature threshold, typically −5 degrees C., preferably the labyrinthine heating unit 332 is operated and at least one of heating elements 322 and 324 are additionally operated in order to maintain the liquid in liquid heating chamber 302 at typically +5 degrees C.

If, the outside temperature measured by the outside temperature sensor 352 is less than the second temperature threshold, preferably the labyrinthine heating unit 332 is operated and at least one of heating elements 322 and 324 are also operated in order to maintain the liquid in liquid heating chamber 302 at typically +20 degrees C.

It is noted that preferably, when the liquid heating assembly of FIG. 8 is operated by electronic temperature control circuitry 350 in the standby mode, as described hereinabove, manual operations, such as an immediate spray demand and initiation of the normal operation of the liquid heating assembly may be initiated by a vehicle operator.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A windshield washing system comprising:
a windshield wiper and sprayer assembly comprising:
a windshield wiper assembly;
a windshield wiper driver assembly operative to move said windshield wiper assembly in rotational and linear motion along a vehicle windshield;
a windshield sprayer assembly mounted on said windshield wiper assembly, said windshield sprayer assembly comprising at least one sprayer comprising:
a sprayer housing; and
a sprayer housing closure arranged for selectable positioning relative to said sprayer housing and to assume a first-position permitting spraying and a second position not permitting spraying; and
a windshield sprayer assembly positioning assembly operative in response to said linear motion of said windshield wiper assembly for selectably positioning said sprayer housing closure relative to said sprayer housing in either of said first and second positions in accordance with the rotational position of the windshield wiper assembly.

2-28. (canceled)

29. A windshield sprayer assembly comprising:
at least one sprayer comprising:
a sprayer housing; and
a sprayer housing closure arranged for selectable positioning relative to said sprayer housing and to assume a first position permitting spraying and a second position not permitting spraying; and
a heater heating said sprayer housing.

30-33. (canceled)

34. A windshield washing system comprising:
a windshield wiper and sprayer assembly comprising:
a windshield wiper assembly;
a windshield wiper driver assembly operative to move said windshield wiper assembly in rotational motion along a vehicle windshield;
a windshield sprayer assembly mounted on said windshield wiper assembly, said windshield sprayer assembly comprising at least one sprayer comprising:
a sprayer housing; and
a sprayer housing closure arranged for selectable positioning relative to said sprayer housing and to assume a first position permitting spraying and a second position not permitting spraying; and
a windshield sprayer assembly positioning assembly operative in response to said rotational motion of said windshield wiper assembly for selectably positioning said sprayer housing closure relative to said sprayer housing in either of said first and second positions in accordance with the rotational position of the windshield wiper assembly.

35-51. (canceled)

52. A liquid heating assembly useful with a windshield wiper and sprayer assembly, said liquid heating assembly comprising:
a housing defining a liquid heating chamber; and
a liquid heating volume defining subassembly disposed in said liquid heating chamber and including a base portion and a generally cylindrical wall portion which is provided with a plurality of liquid inlet apertures at various heights therealong.

53-61. (canceled)

62. A liquid heating assembly useful with a windshield wiper and sprayer assembly, said liquid heating assembly comprising:
a housing defining a liquid heating chamber;
a liquid heating volume defining subassembly disposed in said liquid heating chamber and including a base portion and a generally cylindrical wall portion which is provided with at least one liquid inlet aperture; and
a labyrinthine heating unit receiving heated liquid from said liquid heating volume and providing further heated liquid to an outlet.

63-65. (canceled)

66. A liquid heating assembly useful with a windshield wiper and sprayer assembly, said liquid heating assembly comprising:
a housing defining a liquid heating chamber;
a liquid heating volume defining subassembly disposed in said liquid heating chamber and including a base portion and a generally cylindrical wall portion which is provided with at least one liquid inlet aperture; and
a pump, which is not part of the original equipment in a vehicle, which pressurizes liquid received via a conduit from a liquid reservoir, which is part of the original equipment of the vehicle.

67-70. (canceled)

71. A liquid heating assembly useful with a windshield wiper and sprayer assembly, said liquid heating assembly comprising:
a housing defining a liquid heating chamber;
a liquid heating volume defining subassembly disposed in said liquid heating chamber and including a base portion and a generally cylindrical wall portion which is provided with at least one liquid inlet aperture; and
a temperature sensor located in a wall of said liquid heating chamber.

72-113. (canceled)

114. A heated liquid circulation system comprising:
a liquid heating assembly; and
a heated liquid circulation assembly for supplying heated liquid from said liquid heating assembly for circulation in thermal heat exchange engagement with at least one of a windshield wiper, a windshield sprayer and a liquid supply conduit for supplying liquid to said windshield sprayer.

115. A heated liquid wiper and sprayer assembly comprising:
a liquid heating assembly;
at least one sprayer;
a heated liquid supply assembly including at least one heated liquid supply conduit for supplying heated liquid from said liquid heating assembly to said at least one sprayer for spraying thereof; and
a heated liquid circulation assembly for supplying heated liquid from said liquid heating assembly for circulation in thermal heat exchange engagement with at least one of a windshield wiper, said at least one sprayer and to said at least one heated liquid supply conduit for heating thereof.

116-153. (canceled)

154. A windshield sprayer controlling system comprising:
a windshield wiper assembly comprising:
a windshield wiper support arm; and
a windshield wiper;
a windshield wiper driver assembly operative to move said windshield wiper assembly in rotational motion along a vehicle windshield; and
at least one windshield sprayer mounted on said windshield wiper assembly, said support arm controlling said at least one windshield sprayer in accordance with the direction of movement of said wiper assembly relative to said windshield.

155-163. (canceled)

164. A heated liquid spray system for vehicles comprising:
a windshield washing subsystem comprising:
a windshield wiper and sprayer assembly comprising:
a windshield wiper assembly;
a windshield wiper driver assembly operative to move said windshield wiper assembly in rotational and linear motion along a vehicle windshield;
a windshield sprayer assembly mounted on said windshield wiper assembly, said windshield sprayer assembly comprising at least one sprayer comprising:
a sprayer housing; and
a sprayer housing closure arranged for selectable positioning relative to said sprayer housing and to assume a first position permitting spraying and a second position not permitting spraying; and
a windshield sprayer assembly positioning assembly operative in response to said linear motion of said windshield wiper assembly for selectably positioning said housing closure relative to said housing in either of said first and second positions in accordance with the rotational position of the windshield wiper assembly; and
a liquid heating assembly subsystem comprising:
a housing defining a liquid heating chamber; and
a liquid heating volume defining subassembly disposed in said liquid heating chamber and including a base portion and a generally cylindrical wall portion which is provided with at least one liquid inlet aperture.

165. A heated liquid spray system for vehicles comprising:
a windshield washing subsystem comprising:
a windshield wiper and sprayer assembly comprising:
a windshield wiper assembly;
a windshield wiper driver assembly operative to move said windshield wiper assembly in at least rotational motion along a vehicle windshield;
a windshield sprayer assembly mounted on said windshield wiper assembly, said windshield sprayer assembly comprising at least one sprayer comprising:
a sprayer housing; and
a sprayer housing closure arranged for selectable positioning relative to said sprayer housing and to assume a first position permitting spraying and a second position not permitting spraying; and
a windshield sprayer assembly positioning assembly operative in response to said motion of said windshield wiper assembly for selectably positioning said housing closure relative to said housing in either of said first and second positions in accordance with the rotational position of the windshield wiper assembly; and
a liquid heating assembly subsystem comprising:
a housing defining a liquid heating chamber; and
a liquid heating volume defining subassembly disposed in said liquid heating chamber and including a base portion and a generally cylindrical wall portion which is provided with at least one liquid inlet aperture.

166. A heated liquid spray system for vehicles comprising:
a windshield washing subsystem comprising:
a windshield wiper and sprayer assembly comprising:
a windshield wiper assembly;
a windshield wiper driver assembly operative to move said windshield wiper assembly in at least rotational motion along a vehicle windshield;
a windshield sprayer assembly mounted on said windshield wiper assembly, said windshield sprayer assembly comprising at least one sprayer comprising:
a sprayer housing; and
a sprayer housing closure arranged for selectable positioning relative to said sprayer housing and to assume a first position permitting spraying and a second position not permitting spraying; and
a windshield sprayer assembly positioning assembly operative in response to said motion of said windshield wiper assembly for selectably positioning said housing closure relative to said housing in either of said first and second positions in accordance with the rotational position of the windshield wiper assembly; and
a liquid heating assembly subsystem comprising:
a housing defining a liquid heating chamber;
a liquid heating volume defining subassembly disposed in said liquid heating chamber; and
a labyrinthine heating unit receiving heated liquid from said liquid heating volume and providing further heated liquid to an outlet.

167. (canceled)

168. A method for windshield washing comprising:
providing a windshield wiper assembly having mounted thereon a windshield sprayer assembly including at least one sprayer including a sprayer housing and a sprayer housing closure movable relative to said sprayer housing, said sprayer housing closure providing a first position permitting spraying and a second position not permitting spraying;
moving said windshield wiper assembly in rotational and linear motion along a vehicle windshield; and
selectably positioning said sprayer housing closure relative to said sprayer housing in either of said first and second positions in response to said linear motion of said windshield wiper assembly in accordance with the rotational position of the windshield wiper assembly.

169-195. (canceled)

196. A method for windshield spraying comprising:
providing at least one sprayer including a sprayer housing and a sprayer housing closure arranged for selectable positioning relative to said sprayer housing and for assuming a first position permitting spraying and a second position not permitting spraying; and
heating said sprayer housing.

197-200. (canceled)

201. A method for windshield washing comprising:
providing a windshield wiper assembly having mounted thereon a windshield sprayer assembly including at least one sprayer including a sprayer housing and a sprayer housing closure relative to said sprayer housing, said sprayer housing closure having a first position permitting spraying and a second position not permitting spraying;
moving said windshield wiper assembly in rotational motion along a vehicle windshield; and
selectably positioning said sprayer housing closure relative to said sprayer housing in either of said first and second positions in accordance with the rotational position of said windshield wiper assembly.

202-218. (canceled)

219. A method for heating liquid for use with a windshield wiper and sprayer assembly comprising:
providing a housing defining a liquid heating chamber; and
disposing a liquid heating volume defining subassembly, including a base portion and a generally cylindrical wall portion, with a plurality of liquid inlet apertures at various heights along said wall portion, in said liquid heating chamber.

220-227. (canceled)

228. A method for heating liquid for use with a windshield wiper and sprayer assembly comprising:
providing a housing defining a liquid heating chamber;
disposing a liquid heating volume defining subassembly, including a base portion and a generally cylindrical wall portion, including at least one liquid inlet aperture, in said liquid heating chamber;
receiving heated liquid from said liquid heating volume into a labyrinthine heating unit;
further heating said heated liquid; and
providing said further heated liquid from said labyrinthine heating unit to an outlet.

229-231. (canceled)

232. A method for heating liquid useful with a windshield wiper and sprayer assembly:
providing a housing defining a liquid heating chamber;
disposing a liquid heating volume defining subassembly, including a base portion and a generally cylindrical wall portion, including at least one liquid inlet aperture, in said liquid heating chamber;
receiving liquid via a conduit from a liquid reservoir, which is part of the original equipment of a vehicle; and
pressurizing said liquid with a pump, which is not part of the original equipment in said vehicle.

233-235. (canceled)

236. A method for heating liquid for use with a windshield wiper and sprayer assembly comprising:
providing a housing defining a liquid heating chamber;
disposing a liquid heating volume defining subassembly, including a base portion and a generally cylindrical wall portion, including at least one liquid inlet aperture, in said liquid heating chamber;
locating a temperature sensor in a wall of said liquid heating chamber; and
sensing temperature of said liquid via said temperature sensor.

237-319. (canceled)
